(19) United States
(12) Patent Application Publication
(10) Pub. No.: US 2026/0349682 A1
(43) Pub. Date: Nov. 5, 2026

(54) PROGRAM GENERATION METHOD AND PROGRAM GENERATION SYSTEM

(71) Applicant: PANASONIC INTELLECTUAL PROPERTY MANAGEMENT CO., LTD., Osaka (JP)

(72) Inventors: Masanari MORISHITA, Osaka (JP); Wataru OKUMURA, Osaka (JP); Shiori YOKOTA, Osaka (JP); Eriko SAKURAI, Osaka (JP)

(73) Assignee: PANASONIC INTELLECTUAL PROPERTY MANAGEMENT CO., LTD., Osaka (JP)

(21) Appl. No.: 19/545,536

(22) Filed: Feb. 20, 2026

(30) Foreign Application Priority Data
May 2, 2025 (JP) 2025-076922

(51) Int. Cl. G06F 8/35

(52) U.S. Cl. CPC G06F 8/35

(57) ABSTRACT

A program generation method includes acquiring device information related to a device including a robot that executes an operation; acquiring block information related to a processing block group that is a collection of processing blocks in which operations that are capable of being handled by the device are set; acquiring an implementation content by the robot; and generating a program by selecting one or more processing blocks for implementing the implementation content from the processing block group based on the device information, the block information, and the implementation content.

### CROSS-REFERENCE TO RELATED APPLICATIONS

This application is based on and claims priority under 35 USC 119 from Japanese Patent Application No. 2025-076922 filed on May 2, 2025, the contents of which are incorporated herein by reference.

### TECHNICAL FIELD

The present disclosure relates to a program generation method and a program generation system.

### BACKGROUND ART

In the related art, a robot program execution device that executes a program for operating a robot is known. The robot program execution device includes: a display control unit that displays, on a display device, information related to an element work of the robot opposing a workpiece that is a work target of the robot, and a plurality of pieces of identification information that enable an operator to identify each of a plurality of motions ordered by the robot provided in the element work, in association with each other; a storage unit that stores a plurality of robot programs that cause the robot to operate each of the plurality of motions; and a program execution unit that executes, in accordance with an operation input of the operator that selects any one of the plurality of pieces of identification information displayed on the display device, the robot program of the motion corresponding to the selected identification information (refer to Patent Literature 1).

### CITATION LIST

### PATENT LITERATURE

### Patent Literature 1: JP2019-171498A

### SUMMARY OF INVENTION

The present disclosure provides a program generation method and a program generation system capable of easily generating a program for causing a robot to perform a desired operation.

One aspect of the present disclosure is a program generation method including acquiring device information related to a device including a robot that executes an operation; acquiring block information related to a processing block group that is a collection of processing blocks in which operations that are capable of being handled by the device are set; acquiring an implementation content by the robot; and generating a program by selecting one or more processing blocks for implementing the implementation content from the processing block group based on the device information, the block information, and the implementation content.

Furter, one aspect of the present disclosure is a program generation system comprising at least one control unit. The at least one control unit acquires device information related to a device including a robot that executes an operation; acquires block information related to a processing block group that is a collection of processing blocks in which operations that are capable of being handled by the device are set; acquires an implementation content by the robot; and generates a program by selecting one or more processing blocks for implementing the implementation content from the processing block group based on the device information, the block information, and the implementation content.

According to the present disclosure, a program for causing a robot to perform a desired operation can be easily generated.

### BRIEF DESCRIPTION OF DRAWINGS

FIG. 1A is a block diagram illustrating a configuration example of a program generation system according to a first embodiment;

FIG. 1B is a block diagram illustrating a configuration example of an operation terminal;

FIG. 1C is a block diagram illustrating a configuration example of an automatic generation system;

FIG. 2 is a diagram illustrating an example of device information stored in a device DB;

FIG. 3 is a diagram illustrating an example of block information stored in the block DB;

FIG. 4 is a diagram illustrating an example of past record information held by a past record DB;

FIG. 5 is a diagram illustrating that the automatic generation system generates operation information and commentary information based on input information, and outputs output information;

FIG. 6 is a diagram illustrating an example of the input information;

FIG. 7 is a diagram illustrating an example of the output information;

FIG. 8 is a flowchart illustrating an operation example of the program generation system;

FIG. 9 is a diagram illustrating an example of an operation commentary generation processing;

FIG. 10 is a diagram illustrating an example of a device setting screen;

FIG. 11 is a diagram illustrating device information corresponding to each device selected in FIG. 10;

FIG. 12 is a diagram illustrating an example of processing blocks that are executable by the device selected in FIG. 10, and commentary information thereof;

FIG. 13 is a diagram illustrating an example of input of an implementation content;

FIG. 14 is a diagram illustrating that insufficient information on the implementation content is supplemented from the past record DB;

FIG. 15 is a diagram illustrating an example of reference data included in the past record information;

FIG. 16 is a diagram illustrating an example of an operation flow and a commentary in accordance with the input implementation content;

FIG. 17 is a diagram illustrating an example of a prompt (part 1);

FIG. 18 is a diagram illustrating an example of a prompt (part 2);

FIG. 19 is a diagram illustrating an example of a prompt (part 3);

FIG. 20 is a diagram illustrating an example of a prompt (part 4);

FIG. 21 is a diagram illustrating an example of an operation generation support screen;

FIG. 22 is a diagram illustrating an example of storage in the past record DB;

FIG. 23 is a diagram illustrating that insufficient information on the implementation content is supplemented in a dialogue format;

FIG. 24 is a diagram illustrating an example of the operation generation support screen when the operation flow is corrected;

FIG. 25 is a diagram illustrating an example of the input information input to the automatic generation system when the processing blocks are corrected;

FIG. 26 is a diagram illustrating a first example of coordinate setting (part 1);

FIG. 27 is a diagram illustrating the first example of the coordinate setting (part 2);

FIG. 28 is a diagram illustrating a second example of the coordinate setting (part 1);

FIG. 29 is a diagram illustrating the second example of the coordinate setting (part 2);

FIG. 30 is a diagram illustrating the second example of the coordinate setting (part 3);

FIG. 31 is a diagram illustrating the second example of the coordinate setting (part 4);

FIG. 32 is a diagram illustrating a work in a use case;

FIG. 33 is a diagram illustrating an example of a device setting screen in the use case;

FIG. 34 is a diagram illustrating an input example of the implementation contents in the use case;

FIG. 35 is a diagram illustrating a generation example of a provisional operation flow in the use case;

FIG. 36 is a diagram illustrating an example of guidance for direct teaching in the use case;

FIG. 37 is a diagram illustrating a setting example of position information by the direct teaching in the use case;

FIG. 38 is a diagram illustrating an example of reflection of first position information to the operation flow in the use case;

FIG. 39 is a diagram illustrating an example of reflection of second position information to the processing blocks in the operation flow in the use case;

FIG. 40 is a diagram illustrating an example of correction of the operation flow in the use case; and

FIG. 41 is a diagram illustrating an example of regeneration of the operation flow in the use case.

### DESCRIPTION OF EMBODIMENTS

Hereinafter, embodiments will be described in detail with reference to the drawings as appropriate. However, the unnecessarily detailed description may be omitted. For example, detailed description of well-known matters and redundant description of substantially the same configuration may be omitted. This is to avoid unnecessary redundancy in the following description and to facilitate understanding of those skilled in the art. The accompanying drawings and the following description are provided for those skilled in the art to fully understand the present disclosure, and are not intended to limit the scope of the claims.

### Circumstances Leading to Obtaining an Embodiment According to Present Disclosure

In recent years, introduction of robot techniques has been advancing while the necessity of automation has increased. However, it is difficult for a beginner to move a robot, and specialized knowledge and techniques are required. Therefore, a learning cost for learning information necessary for moving a robot is high. Therefore, many people do not receive the benefit of automation.

As a method for solving those problems, there is also a method of executing an operation of a robot by combining processing blocks corresponding to a program for operating the robot using a UI. However, in this method, it is necessary for a user to select and combine the processing blocks, and thus it is necessary to understand the robot itself or to understand the processing blocks, and it takes time until learning to operate the robot. In a robot program execution method of Patent Literature 1, it is difficult for a beginner in robotics to generate a program for causing the robot to perform a desired operation.

In the following embodiments, a program generation method and a program generation system capable of easily generating a program for causing a robot to perform a desired operation will be described.

### First Embodiment

### Configuration of Program Generation System

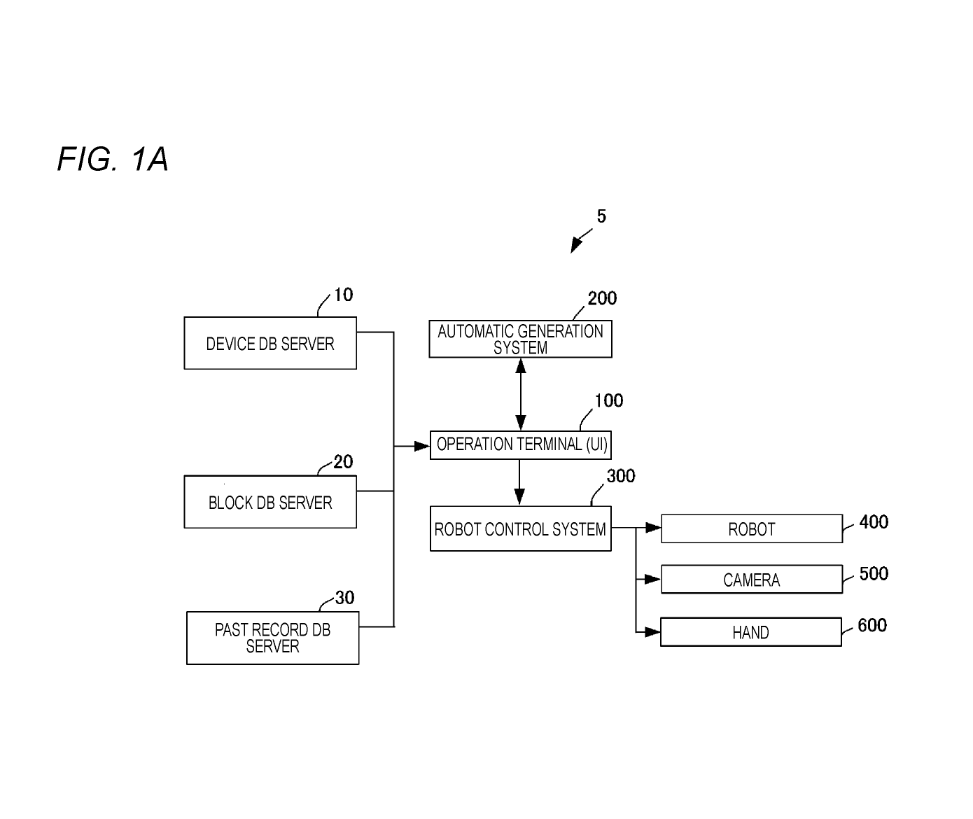

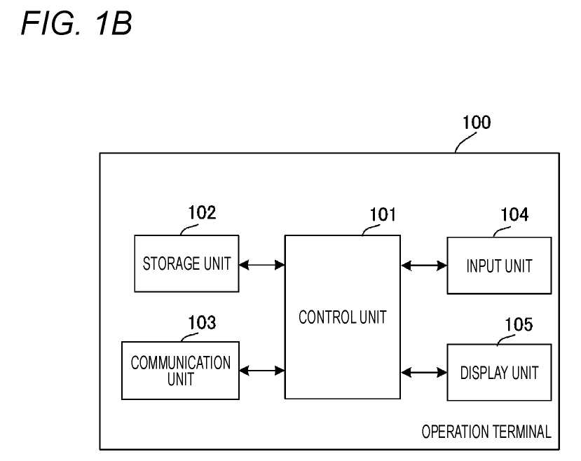

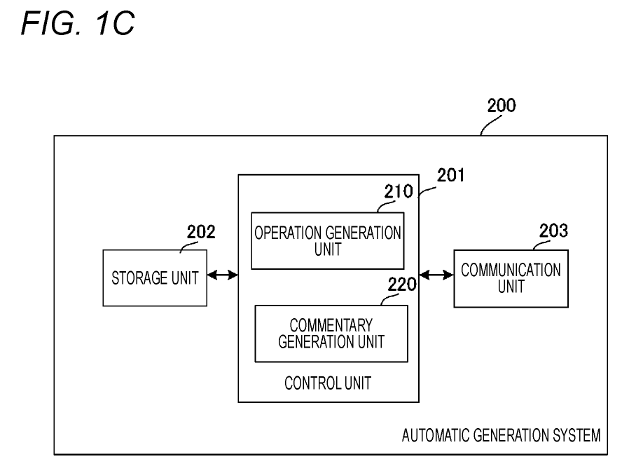

FIG. 1A is a block diagram illustrating a configuration example of a program generation system 5 according to a first embodiment. FIG. 1B is a block diagram illustrating a configuration example of an operation terminal 100. FIG. 1C is a block diagram illustrating a configuration example of an automatic generation system 200.

The program generation system 5 includes a device database (DB) server 10, a block database (DB) server 20, a past record database (DB) server 30, the operation terminal 100, the automatic generation system 200, a robot control system 300, a robot 400, a camera 500, and a hand 600. These devices may be communicatively connected, for example, via wires or wirelessly. These devices may be communicatively connected, for example, via a network. Some of the components of the program generation system 5 (for example, the camera 500) may not be provided. The database is also simply referred to as a DB.

In FIG. 1A, the operation terminal 100 is communicably connected to the device database server 10, the block database server 20, and the past record database server 30, and can acquire various types of information. The operation terminal 100 and the automatic generation system 200 are communicably connected to each other, and can transmit and receive various types of data or information to each other. The robot control system 300 is communicably connected to the operation terminal 100, and acquires various types of data, information, or instructions. The robot control system 300 controls operations of the robot 400, the camera 500, or the hand 600 based on the acquired various types of data, information, or instructions. The robot control system 300 operates as a robot platform that controls various robots (for example, the robot 400, the camera 500, and the hand 600).

The device database server 10 includes a device database (device DB). The device DB accumulates device information related to various devices. The device information may include explanation information explaining various devices. The various devices include, for example, the robot 400, the camera 500, the hand 600, other sensors, and the like.

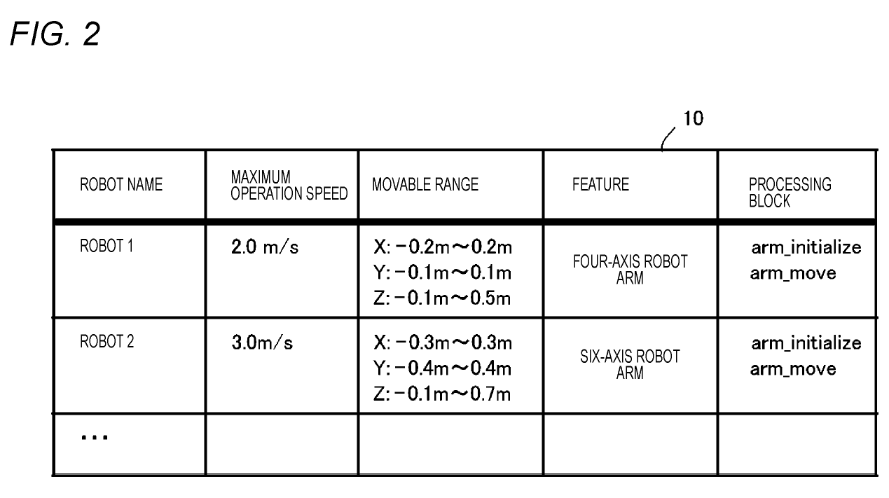

FIG. 2 is a diagram illustrating an example of the device information stored in the device DB. The device information includes, for each of the devices, information, such as identification information (for example, a device name) for identifying the device, a maximum operation speed of the device, a movable range of the device, a feature of the device, and a processing block that can be designated for operating the device, in association with each other. Specifically, the device name is a robot name, a hand name, a camera name (sensor name), and the like.

The block database server 20 includes a block database (block DB). The block DB accumulates block information related to processing blocks corresponding to the devices. The block information may include explanation information explaining the processing blocks. The processing block defines at least a part of operations of the device such as the robot 400. The processing block corresponds to a program for executing at least a part of the operations of the device. The block DB may hold the processing blocks and the corresponding programs in association with each other. The block information may be information related to a processing block group that is a collection of processing blocks in which the operations that are capable of being handled by the device are set.

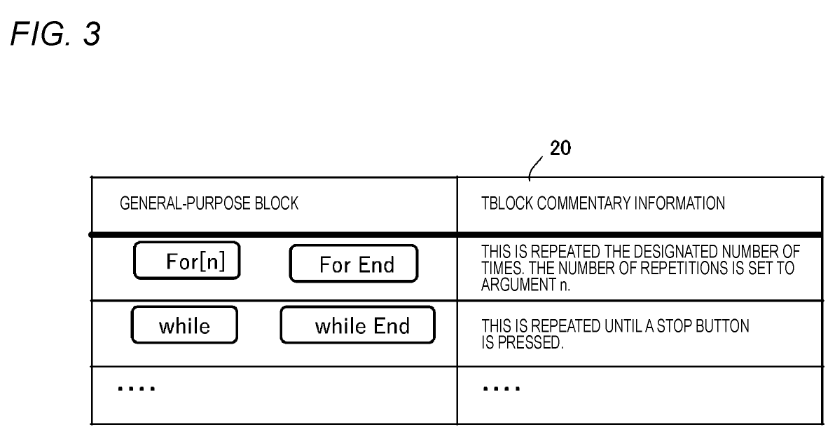

FIG. 3 is a diagram illustrating an example of block information stored in the block DB. The block information includes, for each of the blocks or each block set, identification information (for example, a block name) for identifying a block, and information such as explanation of the block, in association with each other. The processing blocks include a general-purpose block and a device block. The general-purpose block is a processing block that is generally used as a general-purpose program processing independently of the device, and is, for example, "For" or "While". The device block is a processing block for operating various devices, and is, for example, a processing block for moving an arm, a processing block for recognition using a camera or a sensor.

The past record database server 30 includes a past record database (past record DB). The past record DB accumulates past record information related to past execution records of programs corresponding to predetermined processing blocks. The past record information includes a series of executed processing blocks and commentary information that comments on the series of processing blocks. The past record information may include, for example, information related to an operation when picking up an object to be picked up (for example, a plastic bottle and a bag of sweets).

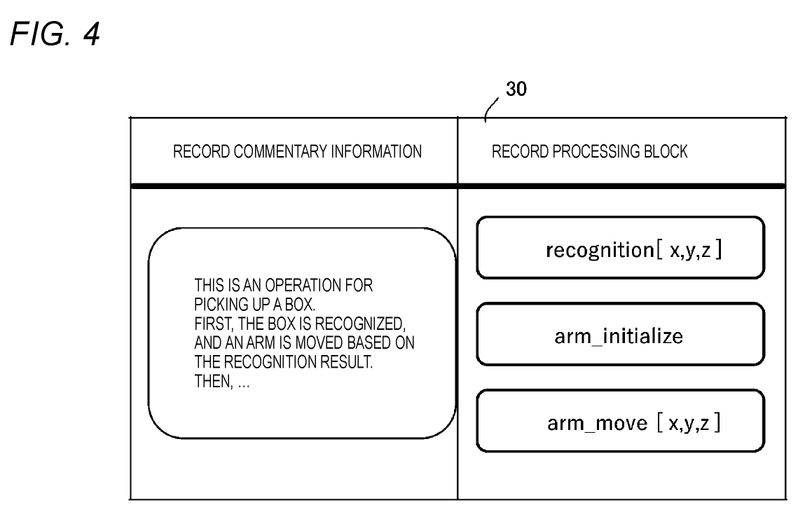

FIG. 4 is a diagram illustrating an example of the past record information held by the past record DB. The past record information includes the commentary information on the executed processing blocks and information on the executed processing blocks and the like, in association with each other. The commentary information can also be said to be information on implementation content that is implemented.

The operation terminal 100 receives various operations and gives instructions according to the operations. The operation terminal 100 may be a PC, a mobile terminal, a smartphone, a tablet terminal, and the like. The operation terminal 100 has the same configuration as a general terminal. As illustrated in FIG. 1B, the operation terminal 100 includes, for example, a control unit 101, a storage unit 102, a communication unit 103, an input unit 104 (operation unit), a display unit 105, and the like.

The operation terminal 100 provides a UI that receives various operations and displays various types of information. The UI includes, for example, a device setting screen for setting various types of information related to the device such as the robot 400. The UI includes, for example, an operation generation support screen for supporting the generation of an operation of the device.

The operation terminal 100 acquires the device information from the device DB and acquires the block information from the block DB. The operation terminal 100 may acquire the past record information from the past record DB. The operation terminal 100 may transmit the device information and the block information to the automatic generation system 200 and transmit the past record information to the automatic generation system 200.

The operation terminal 100 acquires, from the automatic generation system 200, the information on the processing blocks generated by the automatic generation system 200, and the commentary information (also referred to as block commentary information) that comments on the processing blocks. The operation terminal 100 displays various types of information based on the acquired processing blocks and the block commentary information.

The automatic generation system 200 acquires input information including an instruction from the operation terminal 100, and generates, based on the input information, processing blocks that define an operation of the device such as the robot 400, and block commentary information (for example, a commentary text) that comments on a content of the processing blocks, by using a language model of artificial intelligence (AI) such as a large-language model (LLM), a vector search, and the like.

The automatic generation system 200 is implemented, for example, by a server device, and has the same configuration as a general server device. The automatic generation system 200 includes, for example, a control unit 201, a storage unit 202, and a communication unit 203, as illustrated in FIG. 1C. The automatic generation system 200 includes, as functions of the control unit 201, an operation generation unit 210 and a commentary generation unit 220.

The operation generation unit 210 generates operations for various devices such as the robot 400, the camera 500, and the hand 600. Specifically, various types of processing are determined, and a series of processing blocks are generated. A series of processing blocks constitute an operation flow. The operation generation unit 210 includes an LLM for operation generation, and generates processing blocks that define various operations using the LLM for operation generation.

The commentary generation unit 220 generates various types of commentary. Specifically, the block commentary information (that is, operation flow commentary information) that explains the generated processing blocks is generated. The commentary generation unit 220 includes an LLM for commentary generation, and may generate various types of commentary using the LLM for commentary generation.

In the automatic generation system 200, each component or each function may be included in one device, or each component or each function may be arranged in a distributed manner. The automatic generation system 200 may be implemented by a cloud type on a network or may be implemented by an on-premise type server device. A plurality of control units 201 of the automatic generation system 200 may be provided. In addition, at least a part of processing performed by the control unit 201 of the automatic generation system 200 may be performed by the control unit 101 of the operation terminal 100. Therefore, the processing executed by the program generation system 5 is executed by at least one control unit.

The robot control system 300 controls the operations of various devices (for example, the robot 400, the camera 500, and the hand 600). The robot control system 300 acquires information on programs corresponding to the processing blocks generated by the automatic generation system 200 via the operation terminal 100. The robot control system 300 executes the acquired programs to implement control of various functions or operations.

The robot 400 widely includes a robot that performs various works or operations in accordance with the control of the robot control system 300. For example, the robot 400 picks up and places an object (for example, a box).

The camera 500 captures an image of a subject in accordance with the control of the robot control system 300. The camera 500 captures an image of an object to be picked up and placed, for example. The captured image of the object is used to recognize a position, a size, a shape, and the like of the object. A sensor other than the camera 500 may be provided.

The hand 600 operates as a hand of the robot 400. The hand 600 may be, for example, a suction hand, a two-fingered hand, or another hand.

As illustrated in FIG. 1B, the operation terminal 100 includes the control unit 101, the storage unit 102, the communication unit 103, the input unit 104 (operation unit), the display unit 105, and the like.

The control unit 101 may be implemented by a processor. The processor may be implemented using, for example, a central processing unit (CPU), a digital signal processor (DSP), or a graphics processing unit (GPU). The processor may be implemented using various integrated circuits (for example, a large scale integration (LSI) or a field programmable gate array (FPGA)). The control unit 101 implements various functions by executing the program stored in the storage unit 102. The control unit 101 integrally controls units of the operation terminal 100 and performs various types of processing.

The storage unit 102 may be implemented by a memory. The memory may include a random access memory (RAM), a read only memory (ROM), a hard disk drive (HDD), a solid state drive (SSD), an optical disk, an SD card, or the like. The storage unit 102 may be an external storage medium or may be detachable from the operation terminal 100. The storage unit 102 stores various types of data, information, images, programs, trained models, or the like.

The communication unit 103 communicates various types of data or information in accordance with a wired or wireless communication method. The communication method by the communication unit 103 may include a communication method such as a Local Area Network (LAN), a Wide Area Network (WAN), a mobile phone network, or a power line communication.

The input unit 104 may include various buttons, keys, a keyboard, a touch panel, a microphone, or other input units. The input unit 104 receives input of various types of data or information. The input unit 104 is operated by the user. The user is a worker or an administrator who generates a program. The user may be, for example, a beginner of a program or a robot.

The display unit 105 is, for example, a liquid crystal display or an organic EL display. The display unit 105 displays various types of data or information. The display by the display unit 105 may be confirmed by the user, for example.

As illustrated in FIG. 1C, the automatic generation system 200 includes the control unit 201, the storage unit 202, the communication unit 203, and the like.

The control unit 201 may be implemented by a processor. The control unit 201 implements various functions by executing the program stored in the storage unit 202. The control unit 201 integrally controls units of the automatic generation system 200 and performs various types of processing.

The storage unit 202 may be implemented by a memory. The storage unit 202 stores various types of data, information, images, programs, trained models (for example, LLM), or the like.

The communication unit 203 communicates various types of data or information in accordance with a wired or wireless communication method. The communication method of the communication unit 203 may include a communication method such as a LAN, a WAN, a mobile phone network, or a power line communication.

Next, the generation of operations and commentary by the automatic generation system will be described.

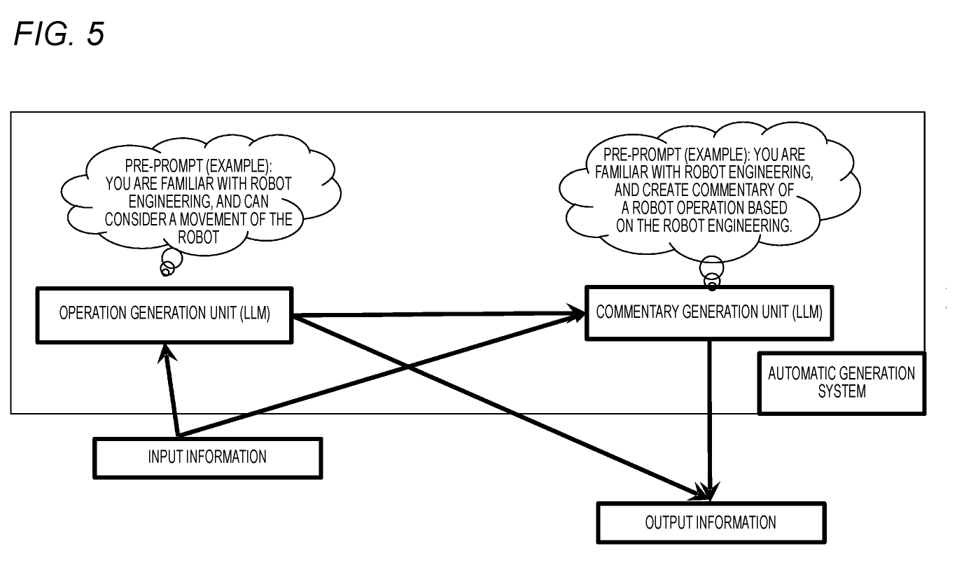

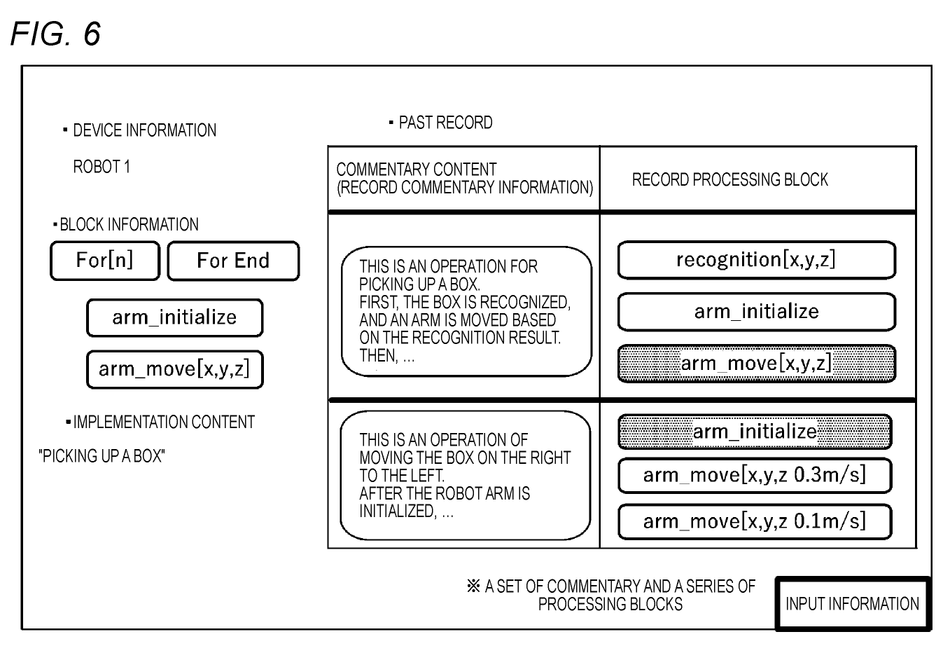

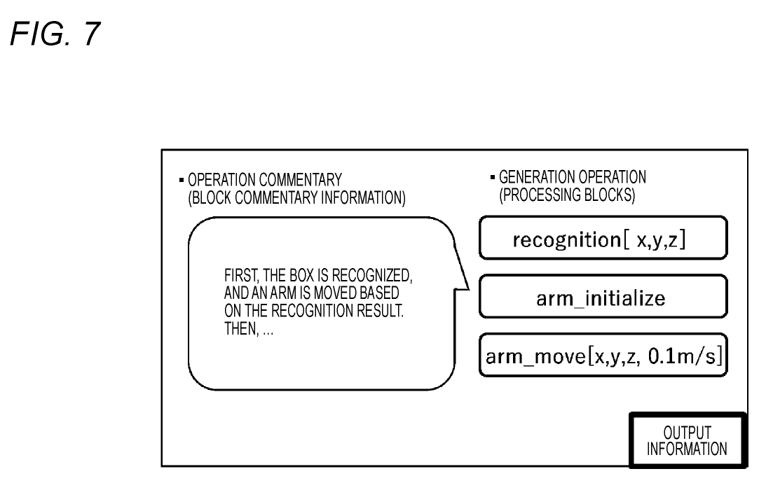

FIG. 5 is a diagram illustrating that the automatic generation system 200 generates operation information and commentary information based on input information, and outputs output information. FIG. 6 is a diagram illustrating an example of the input information. FIG. 7 is a diagram illustrating an example of the output information.

As illustrated in FIG. 6, the input information includes the device information, the block information, the past record information, and the implementation content information. The past record information is a set of information including a series of blocks that define the operation of the device, such as the robot 400, that is implemented in the past, and the commentary thereof. The implementation content information is, for example, information that designates the operation of the robot that the user wants to perform. The implementation content information is input by the user via the input unit 104 of the operation terminal 100, for example. The input information is transmitted from the operation terminal 100 to the automatic generation system 200.

As illustrated in FIG. 5, the operation generation unit 210 generates a series of processing blocks based on the input information with reference to prompts PT1 to PT4 to be described later. That is, based on the device information, the block information, and the implementation content information, the operation generation unit 210 generates one or more processing blocks for implementing the implementation content, and generates a program based on the processing blocks. The overall operation flow is expressed by the series of processing blocks. The control unit 201 selects one or more processing blocks for implementing the implementation content from the processing block group based on the input information, and generates a program. The operation generation unit 210 transmits the operation information (that is, information on the processing blocks) related to the generated operation (generation operation) to the commentary generation unit 220.

The commentary generation unit 220 generates block commentary information that comments on the generated processing blocks based on the input information and the information on the processing blocks with reference to the prompts PT1 to PT4 to be described later. The block commentary information explains what operations the processing blocks perform. That is, the commentary generation unit 220 generates the block commentary information that comments on the generated processing blocks based on the device information, the block information, the implementation contents, and the generated processing blocks.

As illustrated in FIG. 7, the output information includes the information on the processing blocks and the block commentary information. For example, "recognition [x, y, z]" is a processing block of processing for recognizing a three-dimensional position (x, y, z). "arm_initialize" is a processing block of processing for initializing the setting of a position, a speed, and the like of the arm. "arm_move [x, y, z, 0.1 m/s]" is a processing block of processing for moving the three-dimensional position of the arm to a position [x, y, z] at a speed of 0.1 m/s. The operation generation unit 210 generates an operation flow by combining the three processing in this order. The block commentary information includes, for example, information such as "…first, the box is recognized, and the arm is moved based on the result. Then, …". The output information is transmitted from the automatic generation system 200 to the operation terminal 100.

The automatic generation system 200 generates the processing blocks and the block commentary information based on the input information. The automatic generation system 200 can reduce a notation variation of the program when the processing blocks are output from the LLM by expressing a processing flow corresponding to the program using the processing blocks, and can generate the same processing blocks and program on the same input information.

### Operation of Program Generation System

Next, the operation of the program generation system 5 will be described.

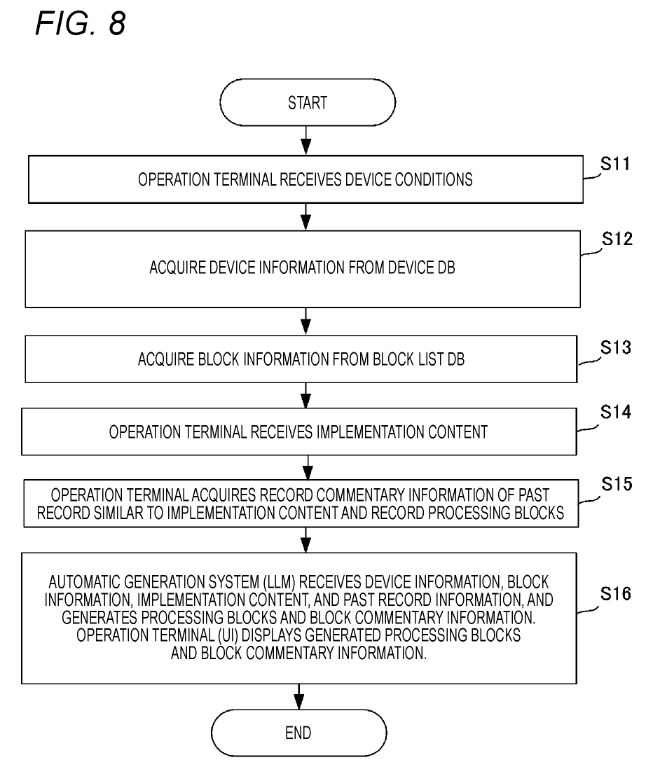

FIG. 8 is a flowchart illustrating an operation example of the program generation system 5. Before starting the processing in FIG. 8, the prompt PT1 is set in advance.

First, the control unit 101 of the operation terminal 100 designates a condition (device condition) related to the device via the input unit 104 (step S11). In this case, the control unit 101 sets information such as the type of the robot or the hand used at the site and the type of the sensor, as the device condition.

The control unit 101 acquires device information satisfying the designated device condition, that is, a device executable at a predetermined site, from the device DB via the communication unit 103 (step S12). In this case, the control unit 101 may acquire a device executable at a predetermined site based on the implementation content information. The control unit 101 acquires block information of the processing blocks that can be processed by the device satisfying the designated device condition from the block DB via the communication unit 103 (step S13). The operation terminal 100 acquires the device information or the block information limited to the information related to the on-site device, thereby preventing the output of the processing blocks that can only be executed by the other devices.

The control unit 101 receives the content (implementation content) of the operation to be implemented by the device such as the robot 400, the camera 500, or the hand 600 via the input unit 104 (step S14).

The operation terminal 100 acquires record commentary information similar to the input implementation content and information on record processing blocks corresponding to the record commentary information with reference to the past record DB (step S15). In this case, the control unit 101 causes the LLM of the automatic generation system 200 to refer to the implementation content input via the communication unit 103 and the past record DB, or performs a vector search. The control unit 201 of the automatic generation system 200 refers to the implementation content and the past record DB, derives the record commentary information that is determined by the LLM to be similar to the input implementation content, and the information on the record processing blocks corresponding to the record commentary information, and notifies the operation terminal 100 of the derived information. Accordingly, the operation terminal 100 can acquire the past record information similar to the input implementation content.

The control unit 101 of the operation terminal 100 transmits the acquired device information, block information, implementation content information, and past record information as the input information to the automatic generation system 200 via the communication unit 103. The control unit 201 of the automatic generation system 200 receives the input information from the operation terminal 100, and generates the processing blocks for implementing the implementation content and the block commentary information of the processing blocks (step S16). The control unit 201 of the automatic generation system 200 transmits output information, including the generated processing blocks and commentary information, to the operation terminal 100 via the communication unit 203.

The control unit 101 of the operation terminal 100 acquires the output information from the automatic generation system 200 via the communication unit 103, and causes the display unit 105 to display the processing blocks and the commentary information based on the output information (step S16).

Accordingly, the user of the operation terminal 100 can confirm the generated processing blocks and block commentary information thereof, and can understand the processing blocks or the operation flow. The processing in step S16 is also referred to as an operation commentary generation processing.

That is, the program generation system 5 can generate the processing blocks that can be reliably executed by the on-site robot, that is, can generate a program corresponding to the processing blocks, by inputting only information (necessary information) that can be executed by the on-site device to the automatic generation system 200 and using processing blocks defined in advance for input and output. In addition, the program generation system 5 also generates the block commentary information (for example, a commentary text), and thus can promote the understanding of the beginner.

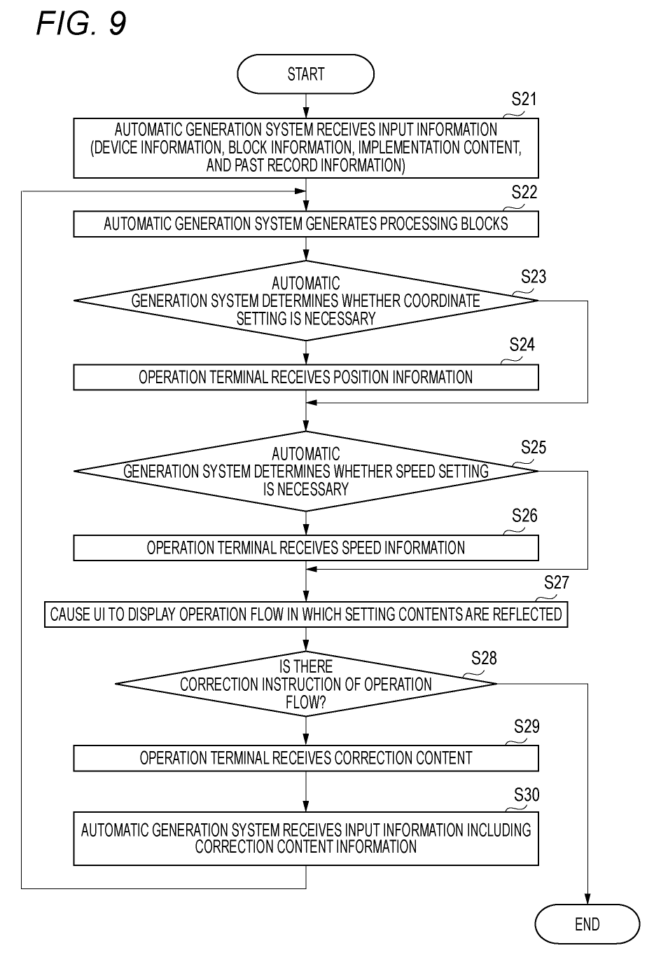

FIG. 9 is a diagram illustrating an example of the operation commentary generation processing in step S16.

The control unit 101 of the operation terminal 100 causes the automatic generation system 200 to receive input information (for example, the device information, the block information, the implementation content information, and the past record information) via the communication unit 103 (step S21).

The control unit 201 of the automatic generation system 200 generates the processing blocks based on the input information using the LLM (step S22).

The control unit 201 determines whether the coordinate setting is necessary in the generated processing blocks (step S23). For example, when the generated processing blocks include a processing block for which the setting of position information (that is, the coordinate setting) is necessary, the control unit 201 determines that the coordinate setting is necessary.

When the coordinate setting is necessary (Yes in step S23), the control unit 201 notifies the operation terminal 100 via the communication unit 203 that the coordinate setting is necessary. The control unit 101 of the operation terminal 100 causes the display unit 105 to display that the coordinate setting is necessary in the operation terminal 100. The control unit 101 receives coordinate information (step S24).

In this case, the control unit 101 may acquire the coordinate information by the direct teaching. For example, when a person directly grips and moves the arm of the robot, the control unit 101 may acquire detection information in which a position or an angle of the arm is detected by the sensor of the robot, and derive (for example, calculate) the coordinate information in each of the processing blocks based on the detection information, thereby receiving the coordinate information. The control unit 101 may receive the input of the coordinate information from the user via the input unit 104. The control unit 101 transmits the input coordinate information to the automatic generation system 200 via the communication unit 103. The control unit 201 of the automatic generation system 200 acquires the coordinate information from the operation terminal 100 via the communication unit 203.

When the coordinate setting is unnecessary (No in step S23), or after the processing in step S24, the control unit 201 of the automatic generation system 200 determines whether speed setting is necessary in the generated processing blocks (step S25). For example, when the generated processing blocks include a processing block for which the setting of speed information (that is, the speed setting) is necessary, the control unit 201 determines that the speed setting is necessary.

When the speed setting is necessary (Yes in step S25), the control unit 201 notifies the operation terminal 100 via the communication unit 203 that the speed setting is necessary. The control unit 101 of the operation terminal 100 causes the display unit 105 to display that the speed setting is necessary in the operation terminal 100. The control unit 101 receives an input from the user via the input unit 104, for example, and receives the speed information (step S26). The control unit 101 transmits the input speed information to the automatic generation system 200 via the communication unit 103. The control unit 201 of the automatic generation system 200 acquires the speed information from the operation terminal 100 via the communication unit 203.

When the speed setting is unnecessary (No in step S25), or after the processing in step S26, when the coordinate information is acquired (supplemented), the control unit 201 of the automatic generation system 200 sets the coordinate information in the processing blocks based on the acquired coordinate information. When the speed information is acquired (supplemented), the control unit 201 sets the speed information in the processing blocks based on the supplemented speed information. The control unit 201 transmits the output information, including the generated processing blocks and the block commentary information of the processing blocks, to the operation terminal 100.

The control unit 101 of the operation terminal 100 acquires the output information from the automatic generation system 200 and causes the display unit 105 (UI) to display the operation flow in which the processing blocks reflecting contents of the setting are combined (step S27).

The user confirms the display of the processing blocks, that is, the operation flow displayed on the operation terminal 100. When the user determines that it is necessary to correct the processing blocks, that is, the operation flow, the user instructs the operation terminal 100 to correct the processing blocks, that is, the operation flow. The control unit 101 of the operation terminal 100 determines whether the correction instruction of the processing blocks, that is, the operation flow is received via the input unit 104 (step S28).

When the correction instruction of the processing blocks, that is, the operation flow is received (Yes in step S28), the control unit 101 receives a correction content of the processing blocks, that is, the operation flow via the input unit 104 (step S29). The control unit 101 transmits the input information, including correction content information related to the correction content, to the automatic generation system 200 via the communication unit 103. The control unit 201 of the automatic generation system 200 receives the input information including the correction content information via the communication unit 203 (step S30). Then, the control unit 201 proceeds to step S22. Accordingly, the automatic generation system 200 can generate the processing blocks to which the correction content is added and the block commentary information thereof.

According to such an operation commentary generation processing, the program generation system 5 can generate the processing blocks while supplementing the coordinate information or the speed information in the processing blocks. Even after the processing blocks are generated once, the correction instruction of the processing blocks is performed, and the processing blocks reflecting the correction instruction and the block commentary information thereof can be regenerated.

Next, a specific example of generating an operation flow will be described.

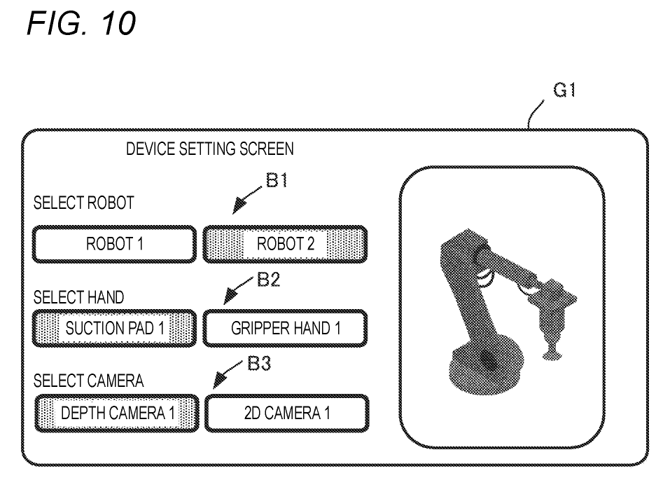

FIG. 10 is a diagram illustrating an example of a device setting screen G1.

The device setting screen G1 is a screen for setting various types of information on the devices such as the robot 400. The device setting screen G1 includes a robot selection button B1 for selecting the robot 400, a hand selection button B2 for selecting a hand of the robot (that is, the hand 600), and a camera selection button B3 for selecting a camera. For example, the user can select information corresponding to a device installed in an automated warehouse at a site. In FIG. 10, a robot 2, a suction pad 1, and a depth camera 1 are selected. The control unit 101 of the operation terminal 100 designates each of the devices by selecting each of the selection buttons via the input unit 104.

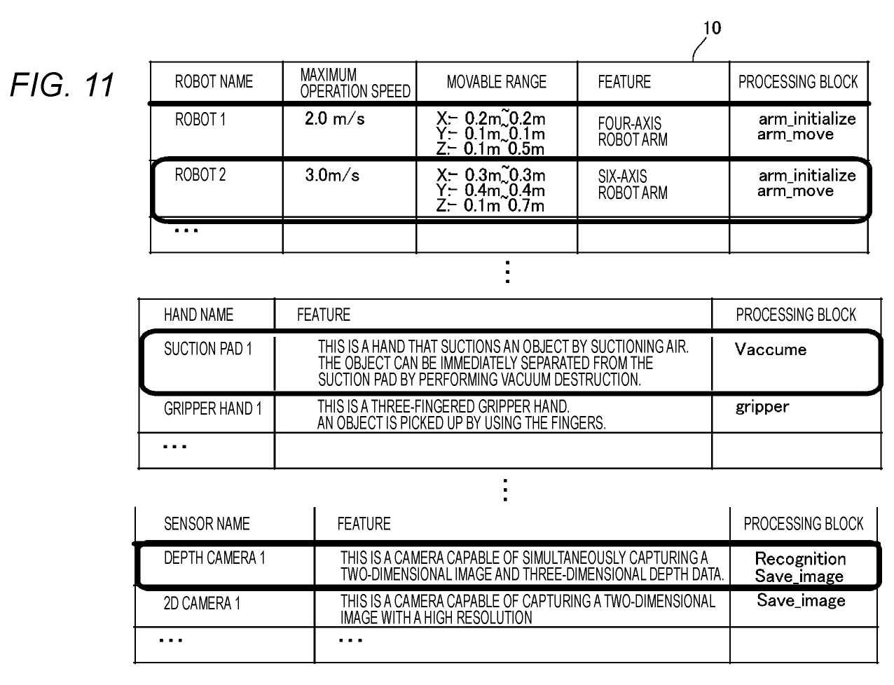

FIG. 11 is a diagram illustrating device information corresponding to each device selected in FIG. 10.

The control unit 101 of the operation terminal 100 acquires device information related to the selected robot 2, device information related to the selected suction pad 1, and device information related to the selected depth camera 1 from the device DB.

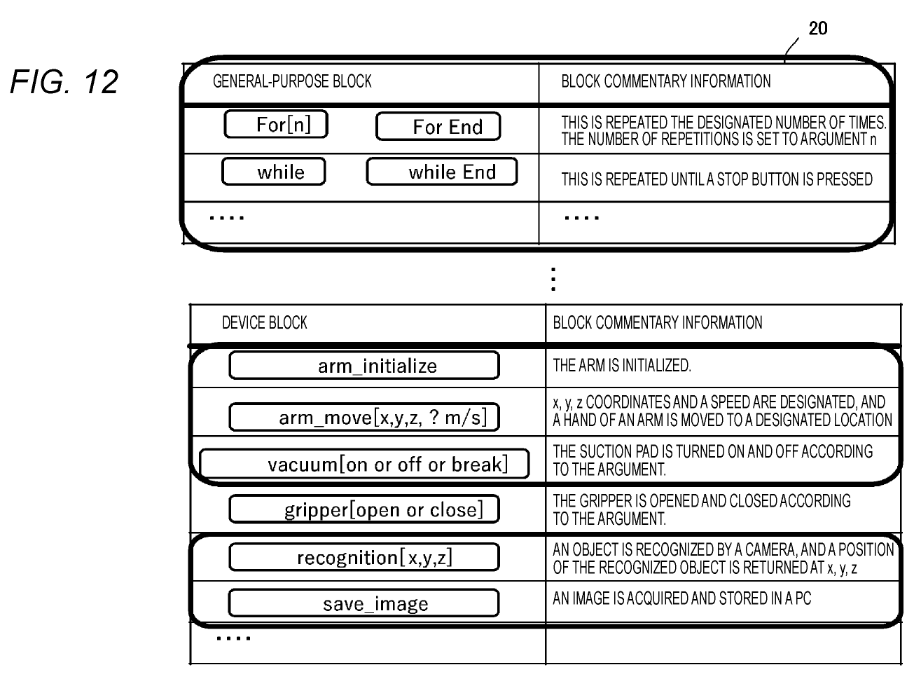

FIG. 12 is a diagram illustrating an example of the processing blocks that are executable by the device selected in FIG. 10, and the commentary information thereof. The processing blocks include, for example, a general-purpose block and a device block.

In FIG. 12, the control unit 101 of the operation terminal 100 acquires respective processing blocks of "For [n]", "For End", "While", and "While End" as the general-purpose blocks, and block commentary information thereof. The control unit 101 of the operation terminal 100 acquires respective processing blocks of "arm_initialize", "arm_move [x, y, z, ? m/s]", "vacuum [on or off or break]", "recognition [x, y, z]", and "save_image" as device blocks, and block commentary information thereof. That is, the operation terminal 100 may acquire not only a processing block specific to a device but also a processing block related to "For" or "If" that is generally used.

Therefore, the operation terminal 100 allows the automatic generation system 200 to refer to only the processing blocks that can be executed by the designated (selected) device, so that the other processing blocks can be prevented from being included in the operation flow.

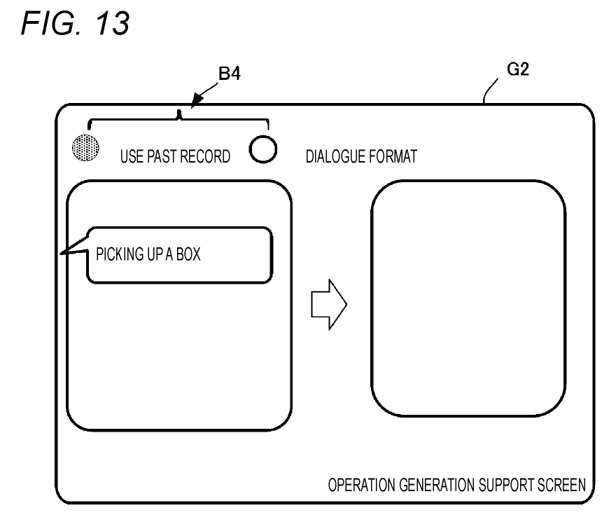

FIG. 13 is a diagram illustrating an example of the input of the implementation content.

In FIG. 13, an operation generation support screen G2 is displayed. The operation generation support screen G2 includes an input display region R1 and a block display region R2. The input display region R1 displays information (for example, implementation content information) input by the operation terminal 100, information acquired (input) from a chat bot, and the like, the automatic generation system 200 functioning as the chat bot. The block display region R2 displays the information on the processing blocks generated by the automatic generation system 200.

The operation generation support screen G2 includes a selection button B4 for selecting a method of acquiring insufficient information (insufficient information) when information for operation generation of the device such as the robot 400 is insufficient in the input implementation content information. The selection button B4 includes a button for selecting the use of the past record information in order to acquire the insufficient information and a button for selecting the use of the dialogue format in order to acquire the insufficient information. The dialogue format is a format in which the user of the operation terminal 100 and a computer (for example, a chat bot) input questions and answers to each other.

In FIG. 13, "picking up a box" is input and displayed as an implementation content.

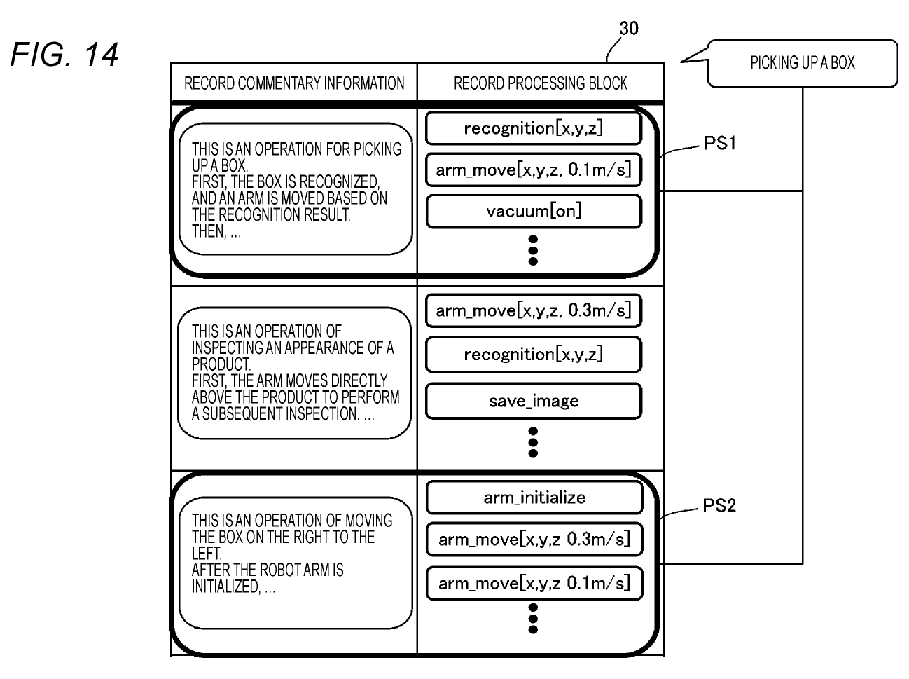

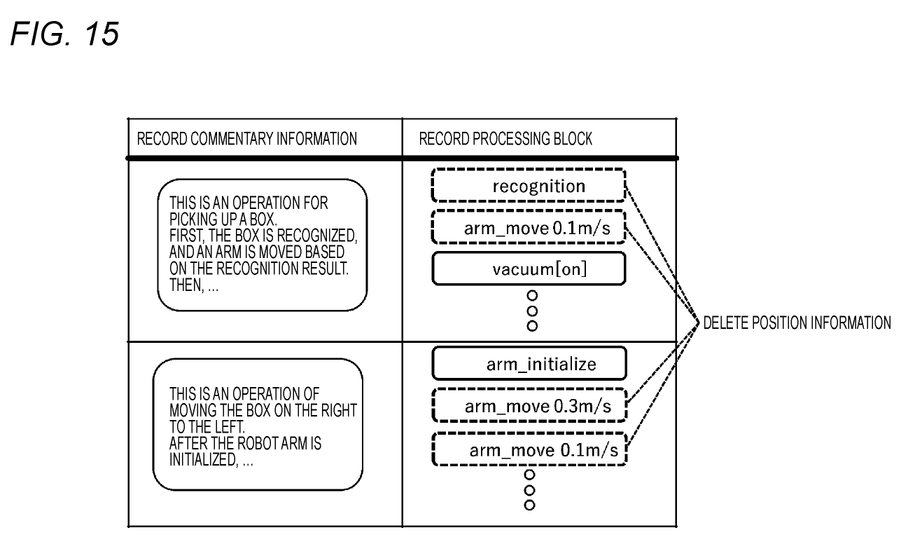

FIG. 14 is a diagram illustrating that the insufficient information on the implementation contents is supplemented from the past record DB. FIG. 15 is a diagram illustrating an example of reference data included in the past record information.

When the implementation content is "picking up a box", that is, when the robot 400 picks up a box, the control unit 101 of the operation terminal 100 transmits the implementation content information to the automatic generation system 200 via the communication unit 103. The control unit 201 of the automatic generation system 200 acquires the implementation content information, specifies the record commentary information similar to the implementation content information, and specifies the record processing blocks corresponding to the record commentary information.

In FIG. 14, the past record DB has two series of processing blocks (processing sets) similar to the picking of a box, for example, processing sets PS1 and PS2. For example, the implementation content is a processing related to the picking of a box, and thus a processing set whose record commentary information includes information on picking up a box or moving a box left and right is identified as a processing set including record commentary information similar to the implementation content information. On the other hand, here, a processing set including a processing related to appearance inspection in the record commentary information is not considered to be a processing set including the record commentary information similar to the implementation content information.

For example, the processing set PS1 includes "recognition [x, y, z]", "arm_move [x, y, z 0.1 m/s]", and "vacuum [on]". The processing set PS2 includes "arm_initialize", "arm_move [x, y, z 0.3 m/s]", and "arm_move [x, y, z 0.1 m/s]".

As the past record information, information related to a series of processing blocks actually executed in the past is held in the past record DB. Specifically, the control unit 201 of the automatic generation system 200 generates the past record information, including the record processing blocks and the record commentary information, by using the generated and executed processing blocks as the record processing blocks and using the block commentary information that comments on the generated and executed processing blocks as the record commentary information. The control unit 201 stores the past record information in the past record DB as a storage unit via the communication unit 203. The control unit 101 of the operation terminal 100 acquires the past record information from the past record DB via the communication unit 103 when necessary.

In addition, the control unit 201 may accumulate the past record information, including the record commentary information summarized in the LLM, in the past record DB. In this case, the automatic generation system 200 can prevent, for example, the past implementation content information input by the user from being accumulated as it is, and can accumulate information related to implementation contents of general-purpose expressions independently of a manner of the input of the user as the past record information.

As illustrated in FIG. 15, the operation terminal 100 and the automatic generation system 200 use the processing sets PS1 and PS2 as reference data for referring to the implementation contents, the operation flow (processing blocks), and an operation speed. An operation position can vary greatly depending on the site, and thus the position information does not need to be referenced. On the other hand, regarding a speed, the hand 600 is moved at high speed immediately after the start of the operation, and is moved at low speed before picking. That is, the speed information may be referred to because of a general idea. That is, the operation terminal 100 and the automatic generation system 200 may refer to the speed information included in the reference data without referring to the position information not included in the reference data.

Therefore, in FIG. 15, in the processing set PS1, the control unit 101 of the operation terminal 100 and the control unit 201 of the automatic generation system 200 may set "recognition [x, y, z] as "recognition" and "arm_move 0.1 m/s" as the reference data. In the processing set PS2, the control unit 101 of the operation terminal 100 and the control unit 201 of the automatic generation system 200 may set "arm_move [x, y, z 0.3 m/s]" as "arm_move 0.3 m/s" and set "arm_move [x, y, z 0.1 m/s]" as "arm_move 0.1 m/s" as the reference data.

In this way, the operation terminal 100 and the automatic generation system 200 can increase a probability that the operation flow defined by the generated processing blocks is actually executable by referring to the processing blocks actually implemented in the past and the operation flow. In addition, the operation terminal 100 and the automatic generation system 200 can supplement the insufficient information on the implementation contents from the past record. The beginner often has insufficient input of the implementation contents, but the operation terminal 100 and the automatic generation system 200 can supplement the insufficient information on the implementation contents, and thus a generation accuracy of the processing blocks and the operation flow can be improved. The beginners include, for example, a beginner who develops a program, a person who has insufficient knowledge related to a robot, and a person who does not develop a program but wishes to use a robot in the site. In addition, the operation terminal 100 and the automatic generation system 200 can derive a processing block having a higher success probability by generating the processing block using the past record information even when the input of the implementation contents is sufficient.

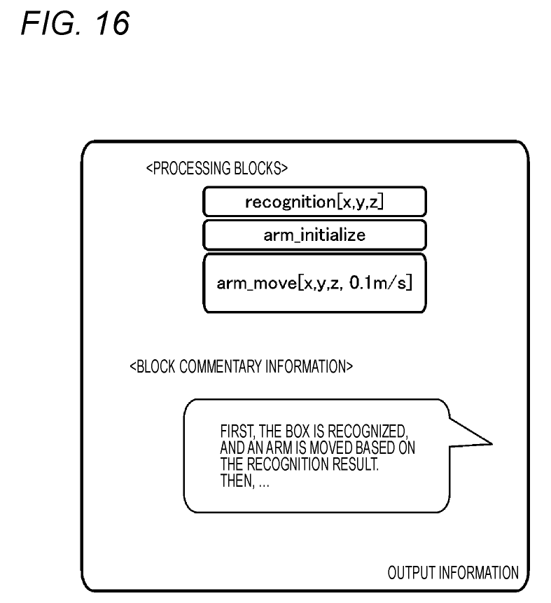

FIG. 16 is a diagram illustrating an example of the operation flow and the commentary in accordance with the input implementation content.

The automatic generation system 200 inputs the device information, the block information, the implementation content information, and the past record information (for example, the reference data) illustrated in FIGS. 10-15 as the input information, generates a series of processing blocks and block commentary information thereof based on the input information, and generates the output information.

In FIG. 16, the output information includes the series of processing blocks and the block commentary information that comments on the series of processing blocks (operation flow). Each of the processing blocks includes "recognition [x, y, z]", "arm_initialize", and "arm_move [x, y, z 0.1 m/s]". That is, specific position information is excluded from the reference data, but the position information is also added to the generated series of processing blocks, and a specific processing can be performed at the site. In addition, the block commentary information of the series of processing blocks includes the information "…first, the box is recognized, and an arm is moved based on the recognition result. Then, …".

### Prompt Example

Next, the prompts input to the automatic generation system 200 will be described.

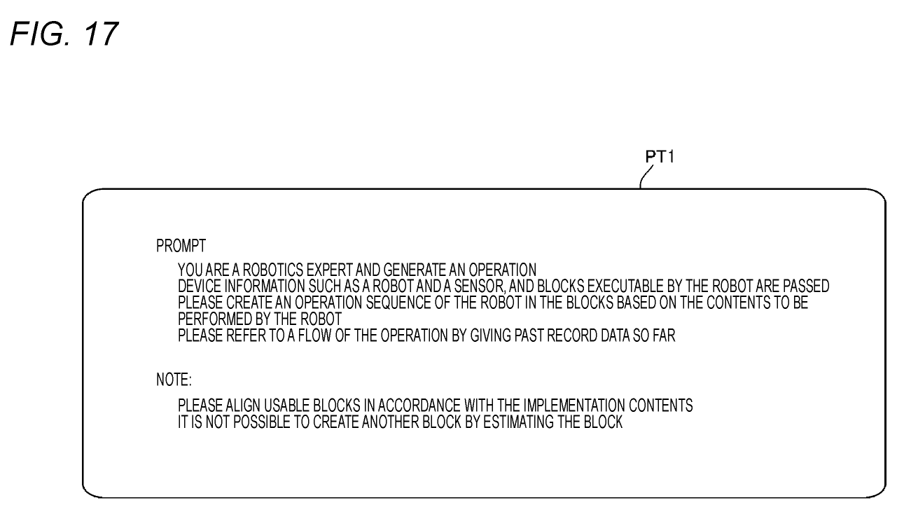

FIG. 17 is a diagram illustrating an example of the prompt PT1.

The prompt PT1 is a prompt that is set in advance to instruct a basic operation of the automatic generation system 200. For example, before generating the processing blocks, the prompt PT1 is input to the automatic generation system 200. The prompt PT1 is referenced by the operation generation unit 210 and the commentary generation unit 220.

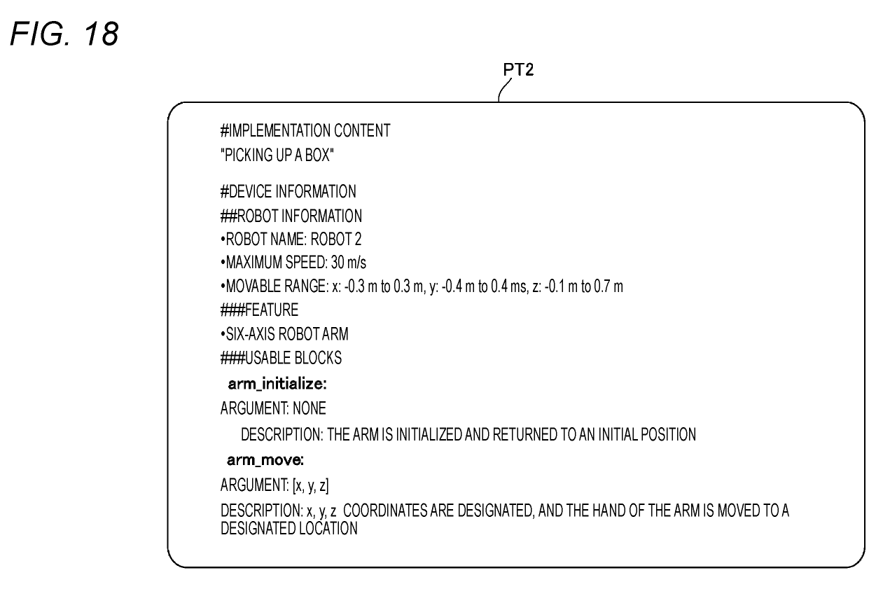

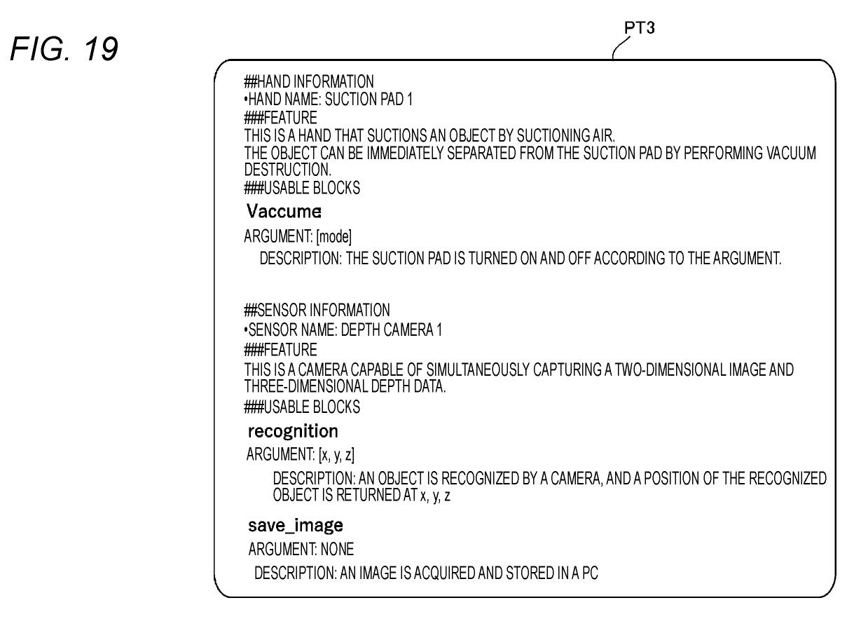

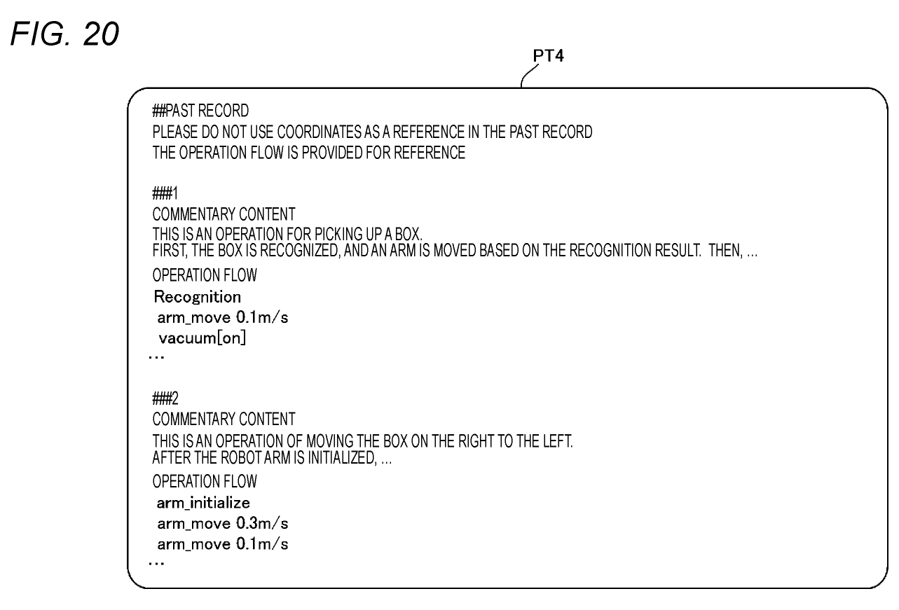

FIG. 18 is a diagram illustrating an example of a prompt PT2. FIG. 19 is a diagram illustrating an example of a prompt PT3. FIG. 20 is a diagram illustrating an example of a prompt PT4. The contents of the prompts PT2 to PT4 are additionally written to the prompt PT1.

The prompts PT2 to PT4 include, as the input information, the implementation content information, the device information, the block information of a device suitable for the site, and the past record information. The device information here is the device information of the device suitable for the site. The block information here is the block information of the processing blocks executable by the device suitable for the site. Each time the implementation contents are input, that is, each time the processing blocks corresponding to the implementation contents are generated, the prompts PT2 to PT4 are transmitted from the operation terminal 100 to the automatic generation system 200, input to the LLM of the automatic generation system 200, and referred to by the LLM.

Next, the confirmation and storage of the generated processing blocks will be described.

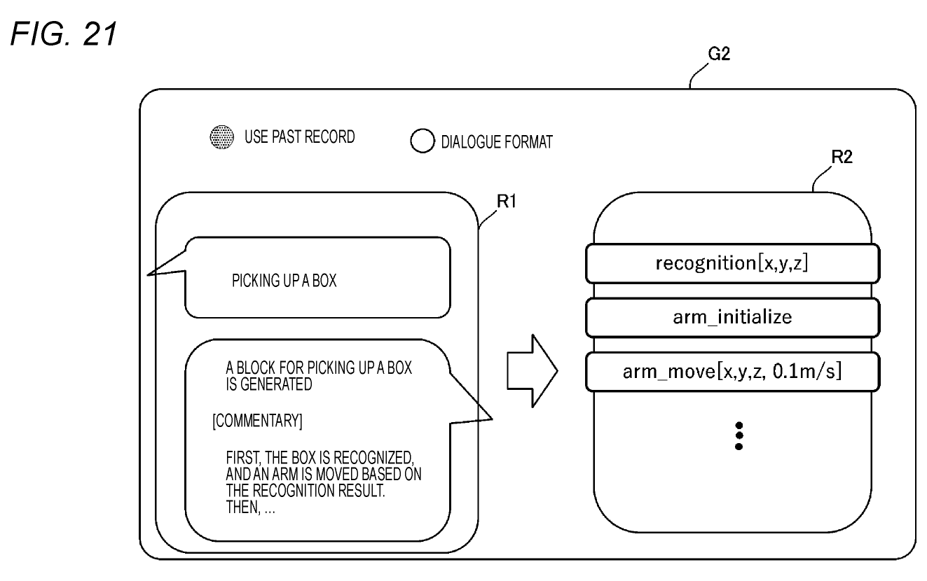

FIG. 21 is a diagram illustrating an example of the operation generation support screen G2.

The display unit 105 of the operation terminal 100 displays the implementation content information related to the input implementation contents in the input display region R1. When the control unit 101 acquires the output information from the automatic generation system 200 via the communication unit 103, the control unit 101 causes the input display region R1 to display information indicating that the generation of the processing blocks is completed based on the output information, and the block commentary information. In addition, the control unit 101 causes the block display region R2 to display the generated processing blocks based on the output information. Therefore, the user can confirm the generated processing blocks and the block commentary information thereof. When the control unit 101 receives a regeneration instruction for re-generating the processing blocks via the input unit 104, for example, the control unit 101 executes the processing blocks, that is, a program corresponding to the processing blocks.

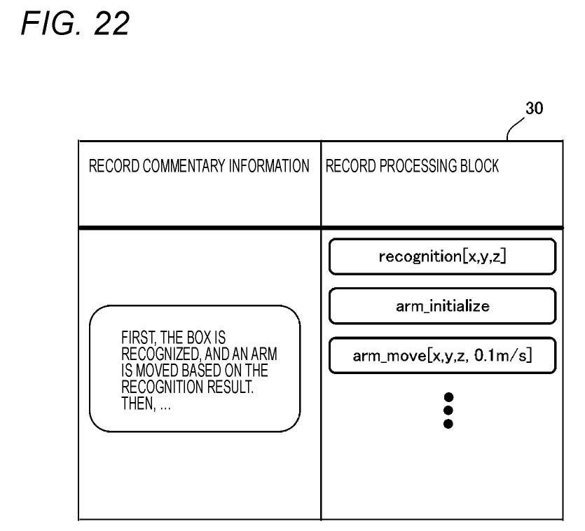

FIG. 22 is a diagram illustrating an example of storage in the past record DB.

The control unit 201 of the automatic generation system 200 stores a set of the executed processing blocks and the block commentary information thereof in the past record DB as an actually executed past record. In this case, the control unit 201 generates the past record information, including the record processing blocks and the record commentary information, by using the executed processing blocks as the record processing blocks and using the block commentary information that comments on the executed processing blocks as the record commentary information. Then, the control unit 201 transmits the past record information to the past record DB of the past record database server 30 via the communication unit 203 and accumulates the past record information. The control unit 201 may generate past record information that includes an execution time or an execution duration of the processing blocks.

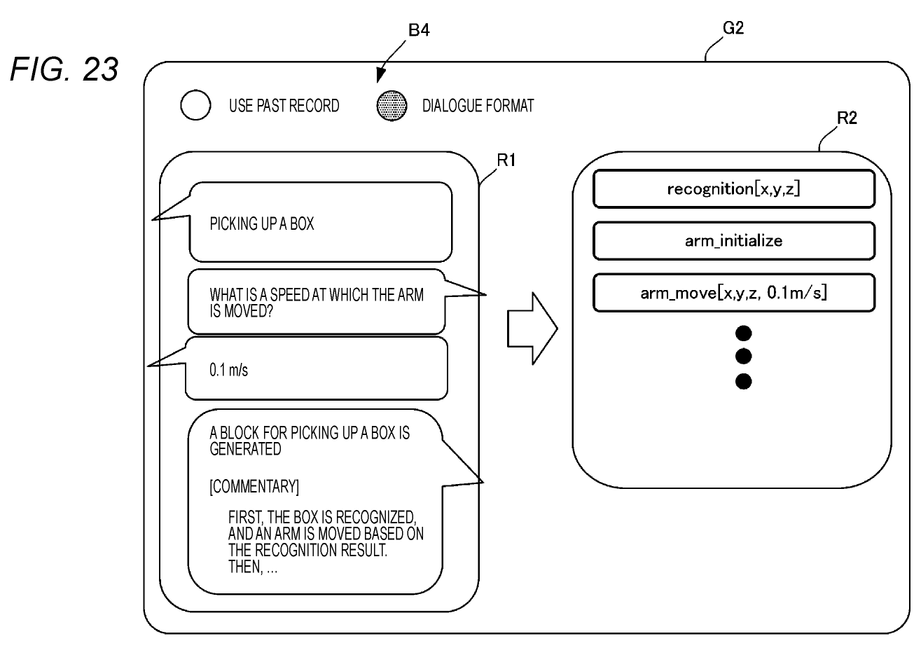

FIG. 23 is a diagram illustrating that the insufficient information on the implementation content is supplemented in a dialogue format.

When the use of the dialogue format is selected by the selection button B4, the control unit 101 of the operation terminal 100 supplements the insufficient information on the implementation content according to the dialogue format based on the questions and the answers with the chat bot.

For example, when an implementation content of picking up a box is input, the control unit 101 acquires a question about a speed at which the arm is moved from the chat bot (specifically, the control unit 201 of the automatic generation system 200) via the communication unit 103 and displays the question, and acquires an answer about a value of the speed in response to an input from the user via the input unit 104 and displays the answer.

The control unit 101 transmits the input information, including the speed information, to the automatic generation system 200 via the communication unit 103. Here, it is assumed that the insufficient information is supplemented by information obtained in a dialogue format instead of using the past record information, and thus the input information here does not include the past record information but includes the speed information. The control unit 201 of the automatic generation system 200 generates a processing block including the speed information (for example, "arm_move [x, y, z, 0.1 m/s]") based on the input information including the speed information. The automatic generation system 200 transmits the operation flow, including one or more processing blocks and the block commentary information thereof, to the operation terminal 100. The operation terminal 100 acquires the operation flow including one or more processing blocks and the block commentary information thereof, and causes the block display region R2 to display the operation flow and the block commentary information.

In this way, the operation terminal 100 inputs the implementation content information, repeats the question and the answer when there is insufficient information in the input information, and supports the automatic generation system 200 to generate the processing blocks and the block commentary information thereof. When the insufficient information is supplemented through the questions and answers in a dialogue format, the prompt PT1 is set in advance such that a question is asked when there is information insufficient for the prompt PT2 of the LLM based on the input information.

Here, it is exemplified that the insufficient information is supplemented based on the information obtained through the questions and the answers in a dialogue format instead of using the past record information, but the present disclosure is not limited thereto. The control unit 101 of the operation terminal 100 and the control unit 201 of the automatic generation system 200 may supplement the insufficient information by using both the past record information and the information obtained in a dialogue format. In this case, the control unit 101 and the control unit 201 may first supplement the insufficient information by using the past record information, and may further supplement the insufficient information by using the information obtained in a dialogue format when there is still insufficient information.

Next, the correction of the operation flow including the generated processing blocks will be described.

After the processing blocks are generated by the automatic generation system 200, the program generation system 5 can also correct the operation flow. The operation flow is corrected based on the dialogue format.

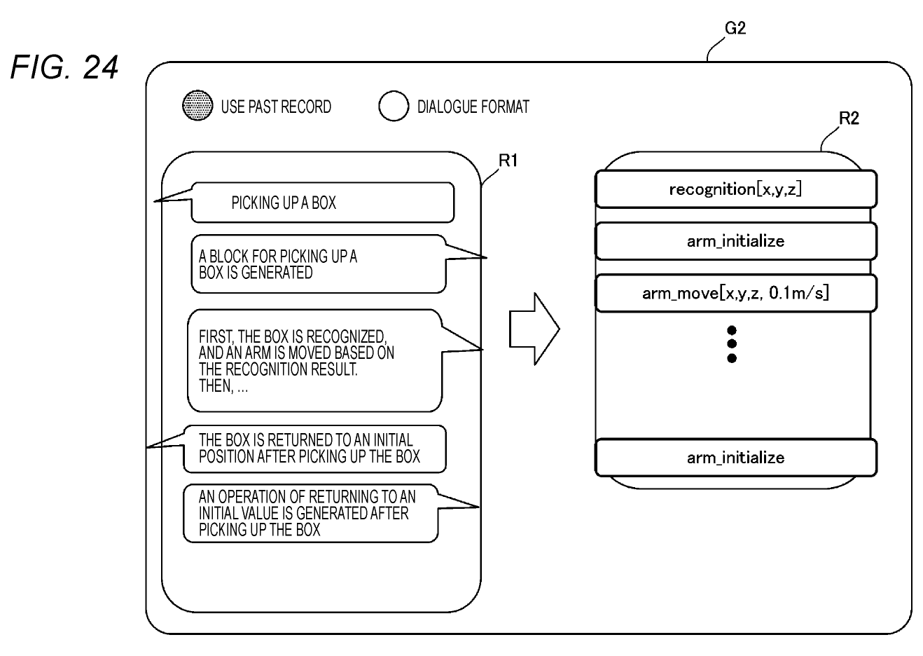

FIG. 24 is a diagram illustrating an example of the operation generation support screen G2 when the operation flow is corrected.

In FIG. 24, the control unit 201 of the automatic generation system 200 generates the processing blocks and the block commentary information thereof based on initial input information. The control unit 101 of the operation terminal 100 acquires the processing blocks and the block commentary information thereof via the communication unit 103. Then, the control unit 101 causes the input display region R1 to display a message that the processing blocks are generated, and the block commentary information of the processing blocks, and causes the block display region R2 to display the operation flow. The user of the operation terminal 100 confirms this display and instructs a correction as necessary.

For example, the control unit 101 of the operation terminal 100 receives, via the input unit 104, a correction instruction (addition instruction) of an operation in which the robot 400 returns to an initial position after picking up the box. The control unit 101 transmits the input information, including the information (correction information) input by the correction instruction, to the automatic generation system 200 via the communication unit 103.

The control unit 201 of the automatic generation system 200 acquires the input information including the correction information via the communication unit 203, and generates (regenerates) a series of processing blocks including the correction information and the block commentary information thereof based on the input information including the correction information. The series of processing blocks here include a processing block (for example, "arm_initialize") including correction information. The control unit 201 transmits the series of processing blocks and the block commentary information thereof to the operation terminal 100 via the communication unit 203. The control unit 101 of the operation terminal 100 acquires a series of processing blocks and the block commentary information thereof via the communication unit 103. Then, the control unit 101 causes the input display region R1 to display that the operation (for example, the operation of returning to the initial position after picking) of the processing blocks corresponding to the correction information is generated, and causes the block display region R2 to display the processing block (for example, "arm_initialize") corresponding to the correction information.

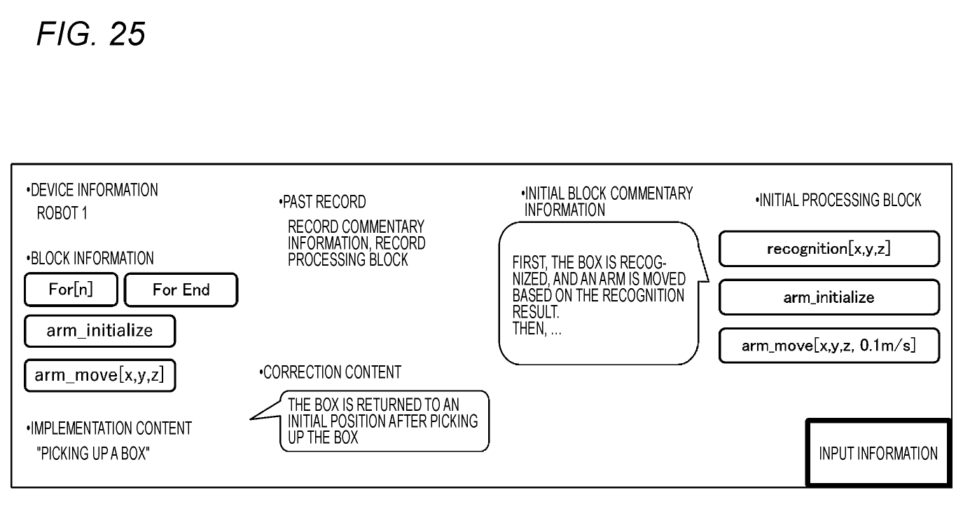

FIG. 25 is a diagram illustrating an example of the input information input to the automatic generation system 200 when the processing blocks are corrected.

The input information input to the automatic generation system 200 when the processing blocks are corrected includes, for example, the device information, the block information, the implementation contents, initial output information based on the initial input information (for example, the processing blocks and the block commentary information thereof), and the correction information. That is, the control unit 101 of the operation terminal 100 may include all the information obtained by the operation terminal 100 at the time of correction in the input information. The input information here may not include the original output information. When the input information here also includes the original output information, the automatic generation system 200 can avoid obtaining a result greatly deviating from the initially assumed output information as the output information to which the correction information is added.

Next, the coordinate setting will be described.

As described above, when generating the processing blocks using the past record information, the program generation system 5 can prevent the position information of the past record information from being referred to. In addition, when the insufficient information is supplemented in a dialogue format, the position information may be insufficient. In such a case, the position information is insufficient for generating the processing blocks, and the control unit 101 of the operation terminal 100 may transmit the position information conforming to the on-site device to the automatic generation system 200 via the communication unit 103 and supplement the position information.

The coordinate setting is performed by the direct teaching, for example. Set coordinates are, for example, coordinates indicating a position of the hand connected to the arm of the robot. In the direct teaching, by moving a teaching object (for example, an arm) in a real space, an actual movement of the arm for moving to the position of the set coordinates is taught, and the position of the hand is taught. The direct teaching is performed, for example, when the camera 500 or the sensor is not provided in the real space in which the picking and placing are performed, but may be performed when the camera 500 or the sensor is provided. For example, when the camera 500 needs to recognize an article (for example, a box) to be picked up, but an imaging position for imaging the article is unknown, the imaging position may be taught by the direct teaching.

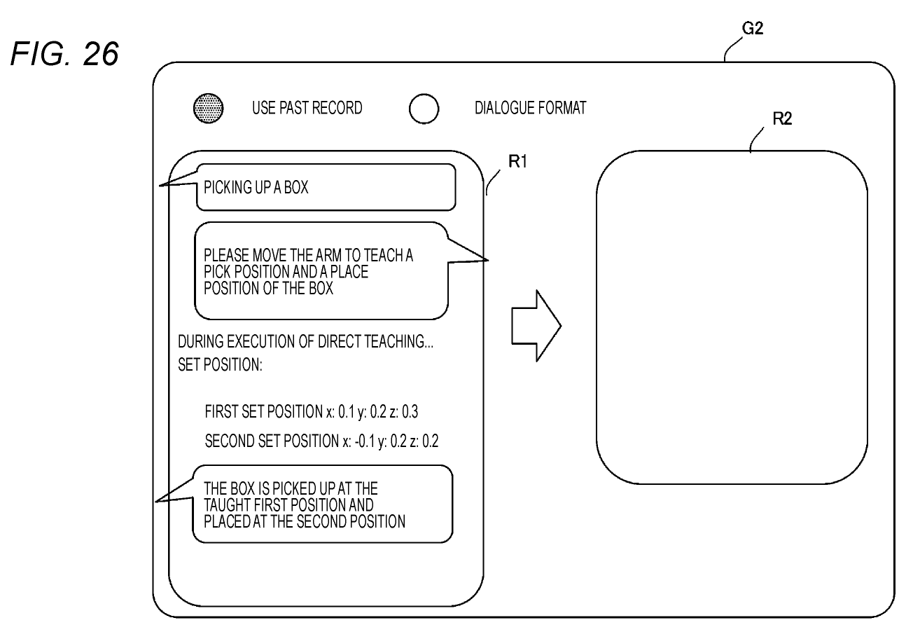

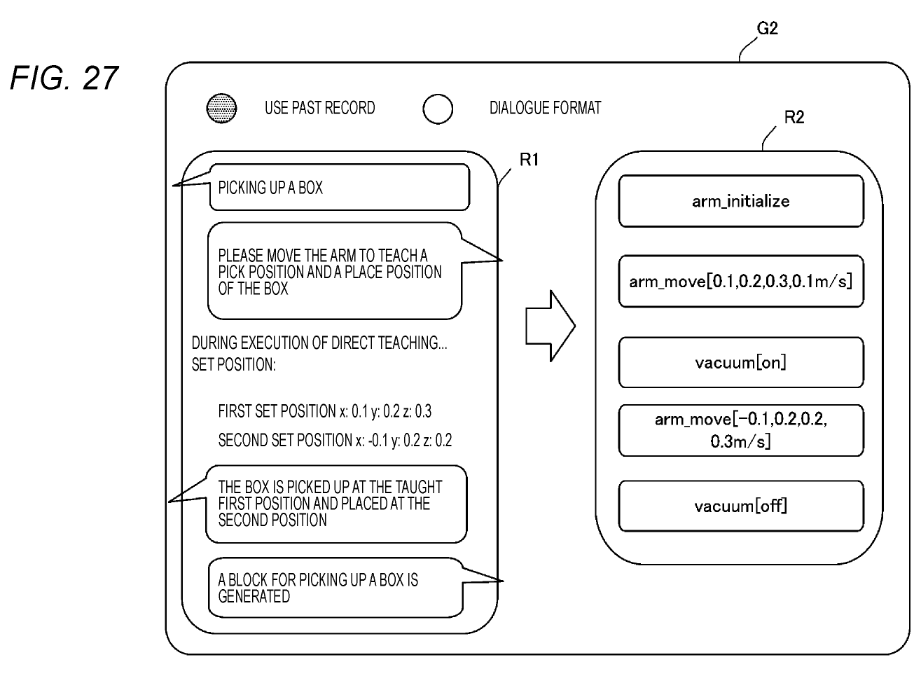

FIGS. 26 and 27 are diagrams illustrating a first example of the coordinate setting.

First, the control unit 101 of the operation terminal 100 generates the implementation content information with picking up a box as the implementation content, and causes the input display region R1 to display the implementation content information. The control unit 201 of the automatic generation system 200 generates the processing blocks based on the input information, recognizes that the position information is insufficient in the processing blocks, and recognizes that the setting of the position information is necessary. The control unit 201 notifies the operation terminal 100 via the communication unit 203 that the setting of the position information is necessary.

When the control unit 101 of the operation terminal 100 acquires the notification that the setting of the position information is necessary via the communication unit 103, the control unit 101 determines that the direct teaching is to be performed, and causes the input display region R1 to display information for prompting the direct teaching. For example, a message "please move the arm to teach a pick position and a place position of the box" is displayed. After the user confirms this display, the user holds the arm and performs the direct teaching. Accordingly, the movement of the arm is detected by, for example, a sensor provided on the robot. The control unit 101 acquires information on the detected movement of the arm via the communication unit 103, for example.

In FIG. 26, the control unit 101 designates two positions (pick position and place position) as set positions. Specifically, the control unit 101 designates position information with a first set position (for example, x = 0.1, y = 0.2, z = 0.3) as the pick position and a second set position (for example, x = -0.1, y = 0.2, z = 0.2) as the place position.

FIG. 27 illustrates that a processing block including the position information obtained by the coordinate setting is generated and displayed.

The control unit 101 of the operation terminal 100 transmits the designated (supplemented) position information to the automatic generation system 200 via the communication unit 103. At this time, the control unit 101 receives, via the input unit 104, information instructing the generation of the processing blocks with the first set position as the pick position and the second set position as the place position, and transmits the instruction information to the automatic generation system 200 via the communication unit 103. In addition, the control unit 101 causes the input display region R1 to display the instruction information.

In accordance with an instruction from the operation terminal 100, the control unit 201 of the automatic generation system 200 sets (that is, sets the coordinates) the supplemented position information in the generated processing block. In FIG. 27, as an example, processing blocks (for example, "arm_move [0.1, 0.2, 0.3, 0.1 m/s]", "arm_move [−0.1, 0.2, 0.2, 0.3 m/s]") in which the position information is set are generated. In this manner, for example, the automatic generation system 200 generates a picking sequence using a result of the direct teaching.

The automatic generation system 200 transmits the operation flow, including one or more processing blocks and the block commentary information thereof, to the operation terminal 100. The operation terminal 100 acquires the operation flow including one or more processing blocks and the commentary information thereof, causes the input display region R1 to display a message that an operation (for example, picking) including the processing blocks in which the position information is set are generated, and causes the block display region R2 to display a series of processing blocks including the position information.

In this way, the automatic generation system 200 generates the processing blocks and the operation flow using the value obtained by the direct teaching.

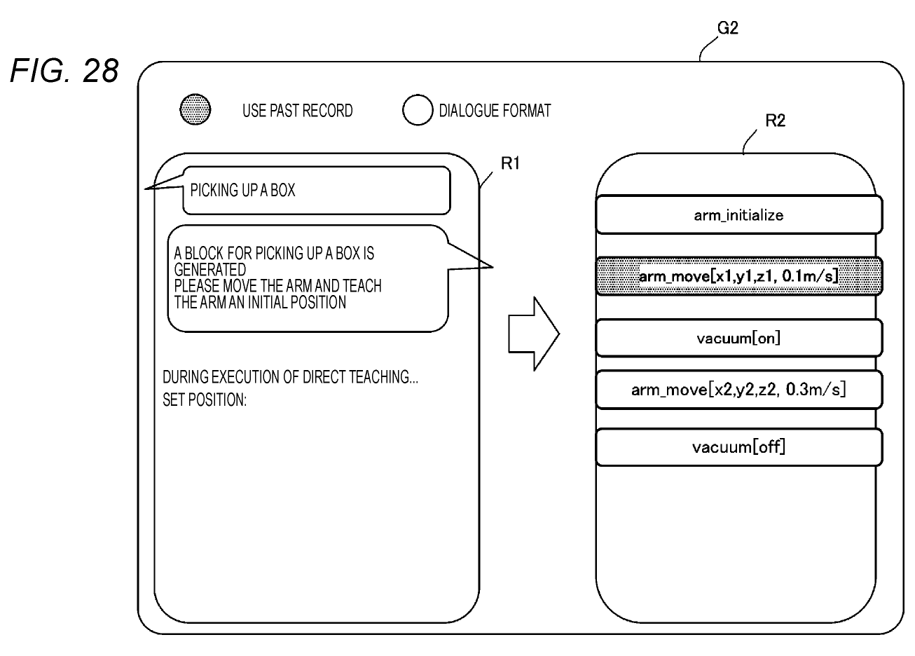

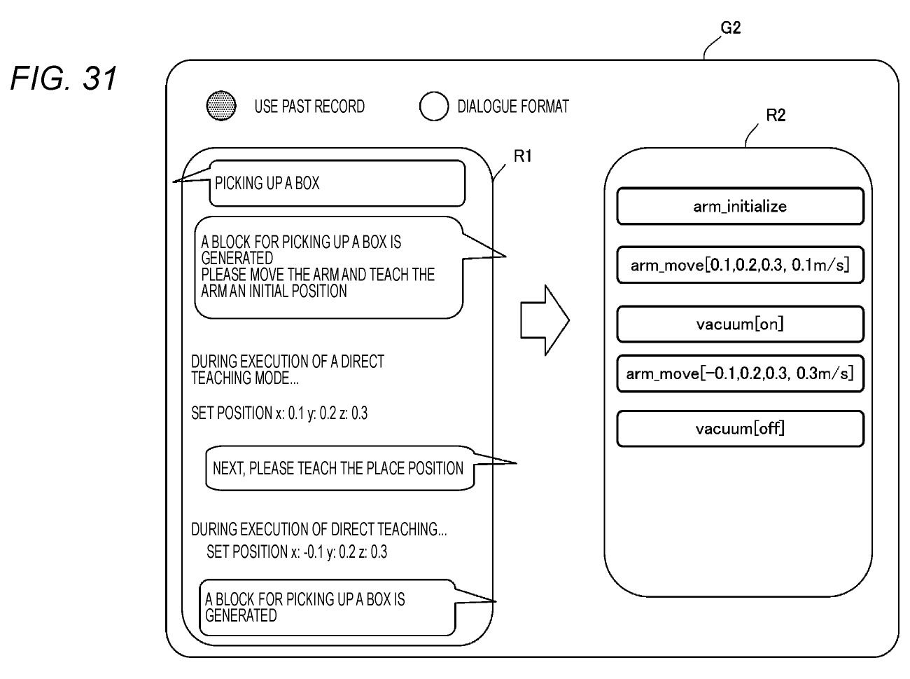

FIGS. 28 and 31 are diagrams illustrating a second example of the coordinate setting. In the second example, the same matters as those in the first example will be omitted or simplified.

FIG. 28 illustrates that a first coordinate setting is performed by the direct teaching.

In the second example, as compared with the first example, when it is designated to pick up a box according to the implementation content information, the control unit 201 of the automatic generation system 200 generates an operation flow including a series of processing blocks for first picking up a box, and transmits the output information to the operation terminal 100 via the communication unit 203. The control unit 101 of the operation terminal 100 causes the input display region R1 to display a message that a series of processing blocks are generated based on the output information, and information prompting the direct teaching, and causes the block display region R2 to display the series of processing blocks.

If it is necessary to set position information for each of the acquired processing blocks, the operation terminal 100 acquires, by the direct teaching, the position information for the processing blocks for which it is necessary to set the position information. A method for acquiring position information by direct teaching may be the same as in the first example.

In FIG. 28, the control unit 201 of the automatic generation system 200 determines that a coordinate setting is necessary in a second processing block ("arm_move [x1, y1, z1, 0.1 m/s]") in the operation flow, and notifies the operation terminal 100 of the result. The control unit 101 of the operation terminal 100 displays the information indicating that the coordinate setting is necessary. For example, the control unit 101 of the operation terminal 100 may display the processing block in which the coordinate setting is necessary in a more emphasized manner than the other processing blocks. The position information designated in the second processing block is pick position information. The control unit 101 of the operation terminal 100 acquires the position information of the pick position obtained by the direct teaching. In addition, the control unit 101 causes the input display region R1 to display information prompting to designate the pick position.

The control unit 101 transmits the acquired (supplemented) position information to the automatic generation system 200 via the communication unit 103. The control unit 201 of the automatic generation system 200 sets the supplemented position information in the generated second processing block, and generates the second processing block in which the position information is set.

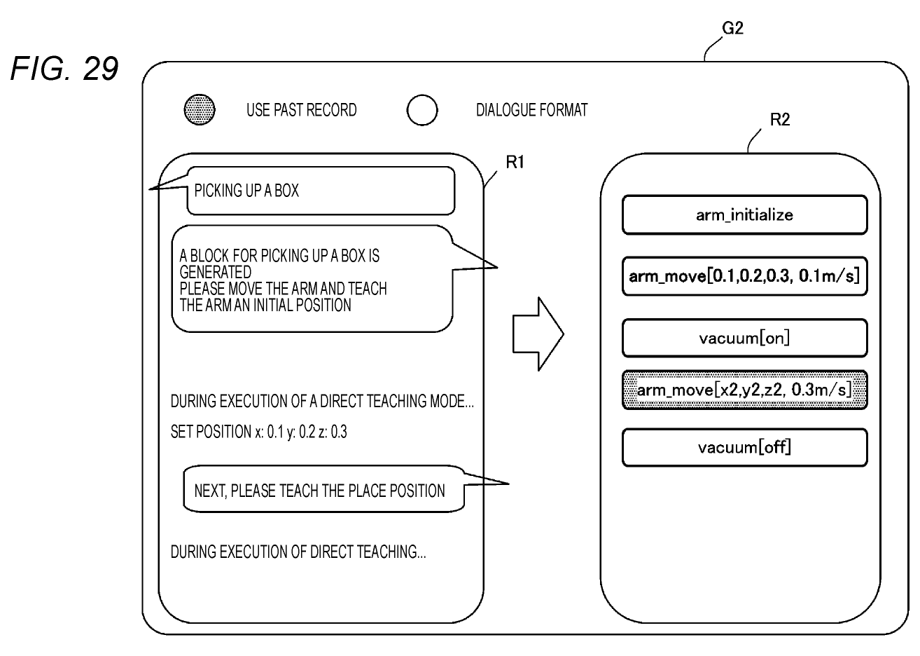

FIG. 29 illustrates that the first coordinate setting is completed by the direct teaching, and a second coordinate setting is performed.

In FIG. 29, the control unit 101 of the operation terminal 100 reflects and displays the position information obtained by the direct teaching in the second processing block. Specifically, the control unit 101 reflects specific coordinate values (for example, x = 0.1, y = 0.2, z = 0.3) in a column of the set position, and causes the input display region R1 to display the values. In addition, the control unit 101 causes the block display region R2 to display the second processing block as "arm move [0.1, 0.2, 0.3, 0.1 m/s]".

In FIG. 29, the control unit 201 of the automatic generation system 200 determines that a coordinate setting is necessary in a fourth processing block ("arm_move [x2, y2, z2, 0.3 m/s]") following the second processing block, and notifies the operation terminal 100 of this result. The control unit 101 of the operation terminal 100 displays the information indicating that the coordinate setting is necessary in the fourth processing block. For example, the operation terminal 100 may display the processing block in which the coordinate setting is necessary in the fourth processing block in a more emphasized manner than the other processing blocks. The position information designated in the fourth processing block is place position information. The control unit 101 of the operation terminal 100 acquires the position information of the place position obtained by the direct teaching. In addition, the control unit 101 causes the input display region R1 to display information prompting to designate the place position.

The control unit 101 transmits the acquired (supplemented) position information to the automatic generation system 200 via the communication unit 103. The control unit 201 of the automatic generation system 200 sets the supplemented position information in the generated fourth processing block, and generates the fourth processing block in which the position information is set.

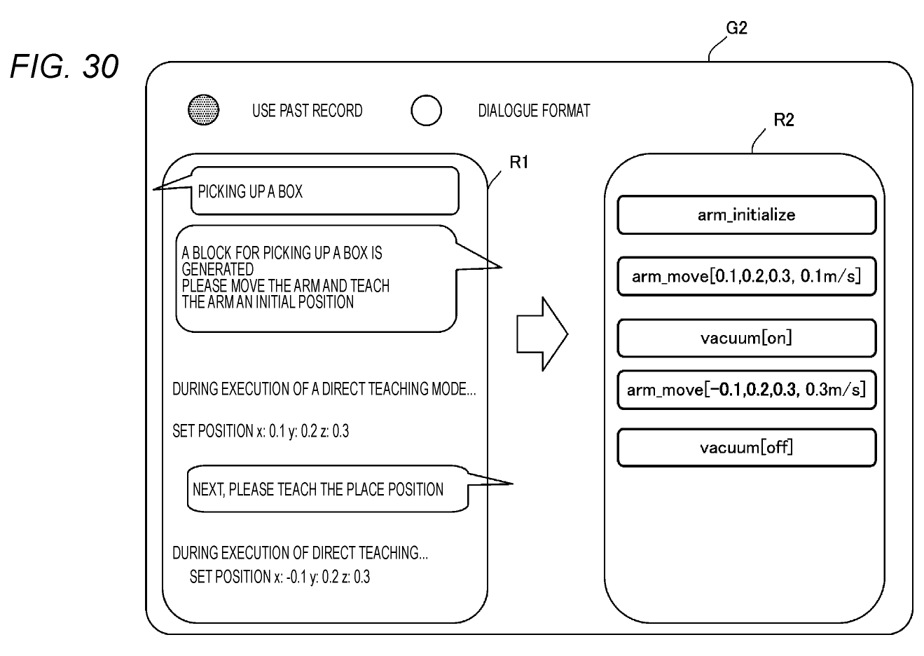

FIG. 30 illustrates that the second coordinate setting is completed by the direct teaching.

In FIG. 30, the control unit 101 of the operation terminal 100 reflects and displays the position information obtained by the direct teaching in the fourth processing block. Specifically, the control unit 101 reflects specific coordinate values (for example, x = -0.1, y = 0.2, z = 0.3) in a column of the set position, and causes the input display region R1 to display the values. In addition, the control unit 101 causes the block display region R2 to display the fourth processing block as "arm_move [-0.1, 0.2, 0.3, 0.3 m/s]".

FIG. 31 illustrates that the coordinate setting for the fourth processing block is completed, and the generation of the operation flow including a series of processing blocks is completed.

The control unit 201 of the automatic generation system 200 determines whether there is another processing block for which the coordinate setting is necessary in the operation flow. When there are no other processing blocks for which the coordinate setting is necessary, the control unit 201 notifies the operation terminal 100 via the communication unit 203 that there are no other processing blocks for which the coordinate setting is necessary. The control unit 101 of the operation terminal 100 receives the notification from the automatic generation system 200, completes the coordinate setting, and causes the input display region R1 to display that the generation of the processing blocks for picking up a box is completed.

When there is another processing block for which the coordinate setting is necessary, the automatic generation system 200 and the operation terminal 100 repeat the same processing as that described with reference to FIGS. 28-30.

As in the second example of such a coordinate setting, the operation terminal 100 may first generate a series of processing blocks, and appropriately set the position information for the processing block in which the position information is insufficient by the direct teaching.

### Use Case

Next, a use case of the program generation system 5 will be described.

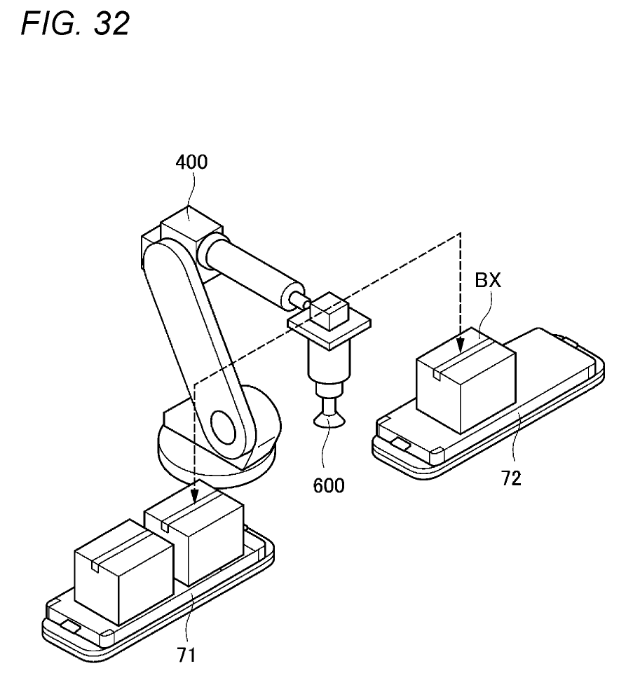

FIG. 32 is a diagram illustrating a work in the use case.

In the use case, it is assumed that the robot 400 capable of recognizing an object generates a program corresponding to an operation of transferring a box BX transported by an automated guided vehicle (AGV) from a storage pallet 71 to a shipping pallet 72. In addition, it is also assumed that the picking and placing are performed after both the storage pallet 71 and the shipping pallet 72 arrive at a picking station. Although the pallet is described here as an example, the pallet may be a bin or another storage tool.

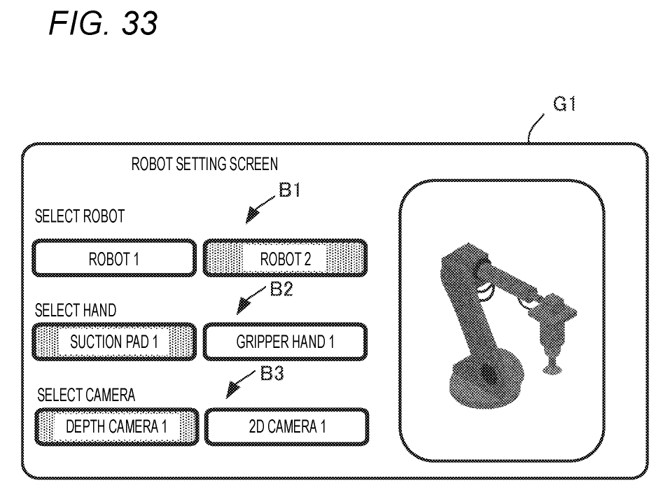

FIG. 33 is a diagram illustrating an example of the device setting screen G1 in the use case.

As described above, the device setting screen G1 includes the robot selection button B1, the hand selection button B2, and the camera selection button B3. In FIG. 33, the robot 2, the suction pad 1, and the depth camera 1 are selected. The depth camera 1 captures an image of a subject (for example, a box to be picked up and placed), and can recognize the box based on the captured image.

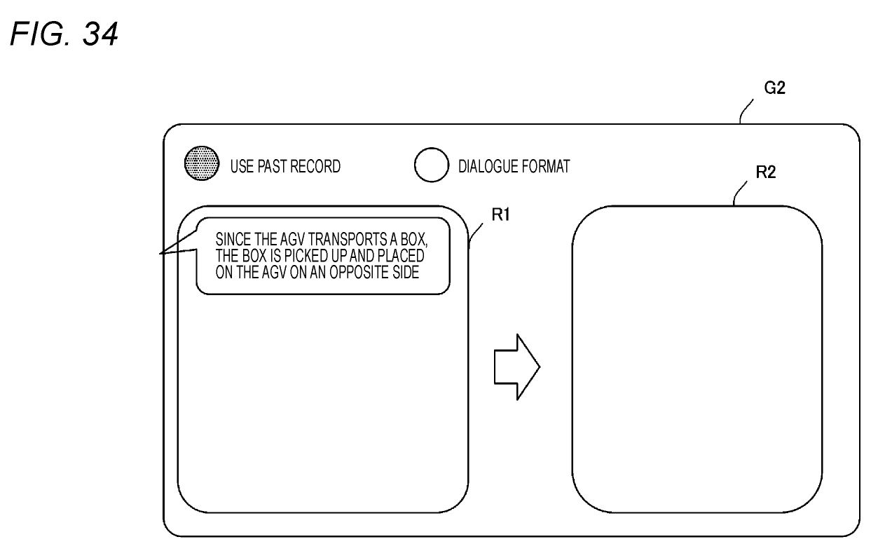

FIG. 34 is a diagram illustrating an input example of the implementation contents in the use case.

In FIG. 34, the selection button B4 is set to use the past record when there is insufficient information in the generation of the processing blocks. The control unit 101 of the operation terminal 100 receives, via the input unit 104, an implementation content "since the AGV transports a box, the box is picked up and placed on the AGV on an opposite side", and generates implementation content information. The control unit 101 transmits the input information, including the device information, the block information, and the implementation content information, to the automatic generation system 200 via the communication unit 103. The input information here may include the past record information including the record commentary information similar to the implementation content information, and the record processing blocks commented in the record commentary information.

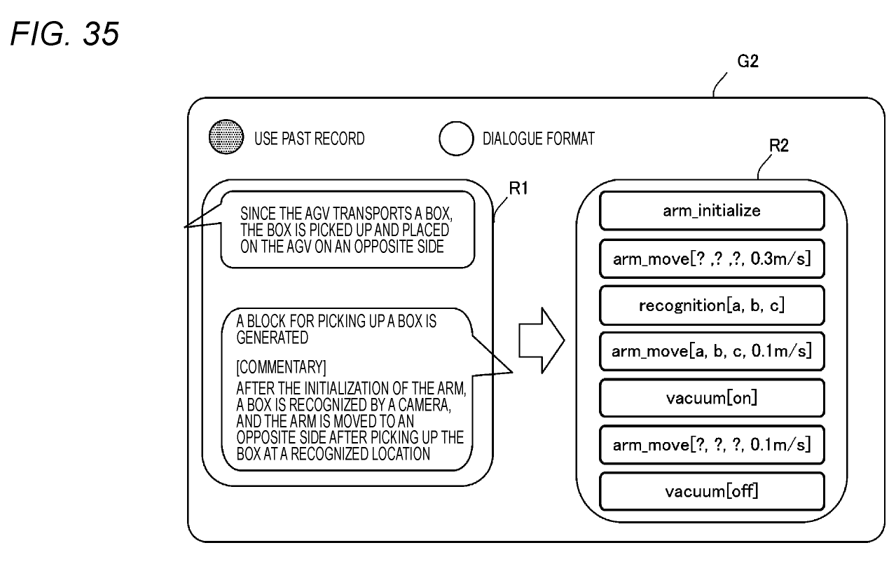

FIG. 35 is a diagram illustrating a generation example of a provisional operation flow in the use case.

The control unit 201 of the automatic generation system 200 acquires the input information via the communication unit 203. That is, the control unit 201 acquires the information on the implementation content performed by the robot. The control unit 201 generates a series of provisional processing blocks based on the input information. In addition, the automatic generation system 200 generates the block commentary information that comments on the series of provisional processing blocks. Here, the series of provisional processing blocks are set because the position information of the generated processing blocks is undetermined. The control unit 201 transmits the series of provisional processing blocks and the block commentary information thereof to the operation terminal 100 via the communication unit 203. The control unit 101 of the operation terminal 100 acquires the series of provisional processing blocks and the block commentary information thereof via the communication unit 103, causes the input display region R1 to display the block commentary information, and causes the block display region R2 to display the series of provisional processing blocks.

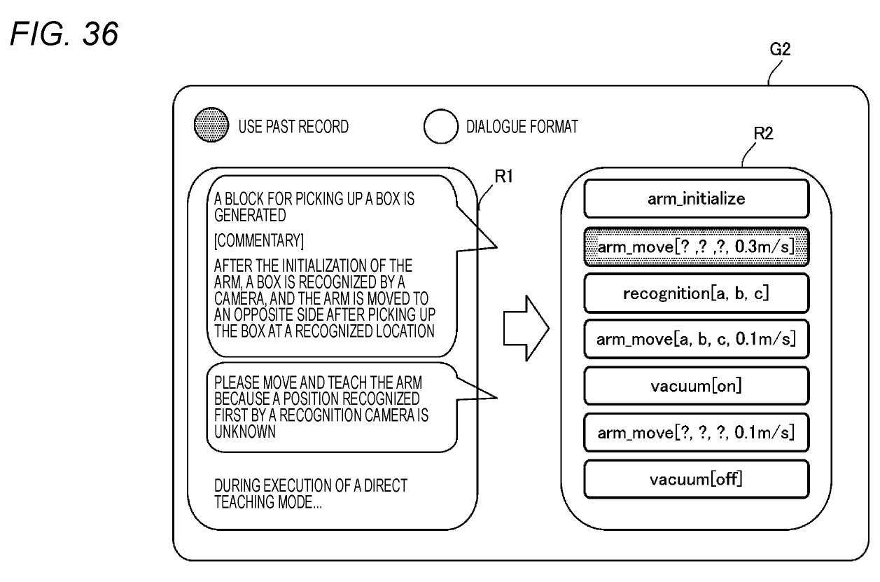

FIG. 36 is a diagram illustrating an example of guidance for the direct teaching in the use case.

When the information is insufficient to generate the processing blocks, that is, when the implementation content information is insufficient, the control unit 101 of the operation terminal 100 causes the input display region R1 to display question information from the chat bot. The question information includes, for example, information such as "please move and teach the arm without knowing a position recognized first by a recognition camera". That is, the control unit 101 performs guidance to teach by the direct teaching using the question information via the display unit 105. The control unit 101 indicates which processing block's position information is to be taught, for example, by highlighting the position information by blinking or the like. FIG. 36 illustrates that the position information of the second processing block is insufficient, and it is necessary to teach the position information.

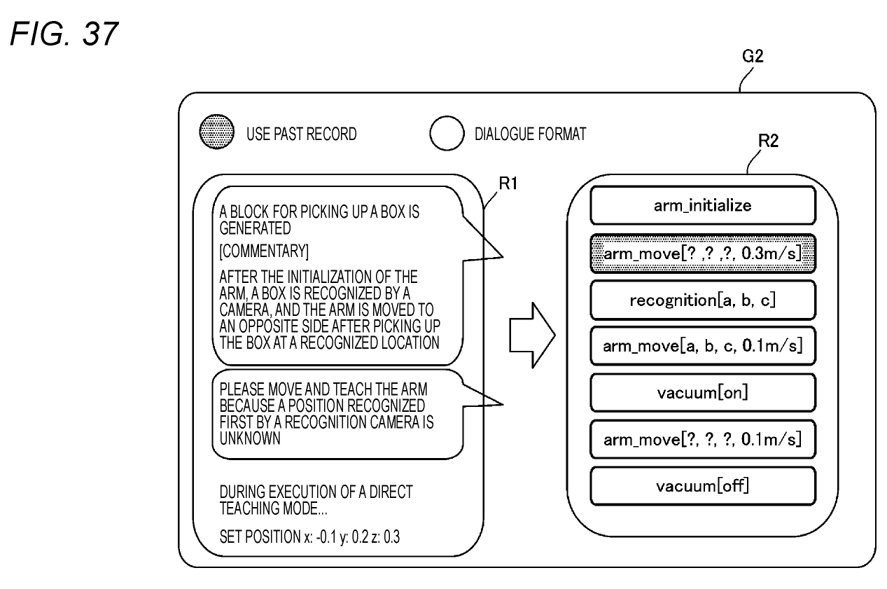

FIG. 37 is a diagram illustrating a setting example of the position information by the direct teaching in the use case.

The user grips the arm of the robot and actually moves the arm to an initial set position (for example, the pick position). At this time, the sensor of the robot 400 recognizes a position or angle of the arm, detects the initial set position based on this recognition information, and transmits the position information of the set position to the operation terminal 100. The control unit 101 of the operation terminal 100 acquires the information on the detected set position via the communication unit 103, and causes the input display region R1 to display the information on the set position.

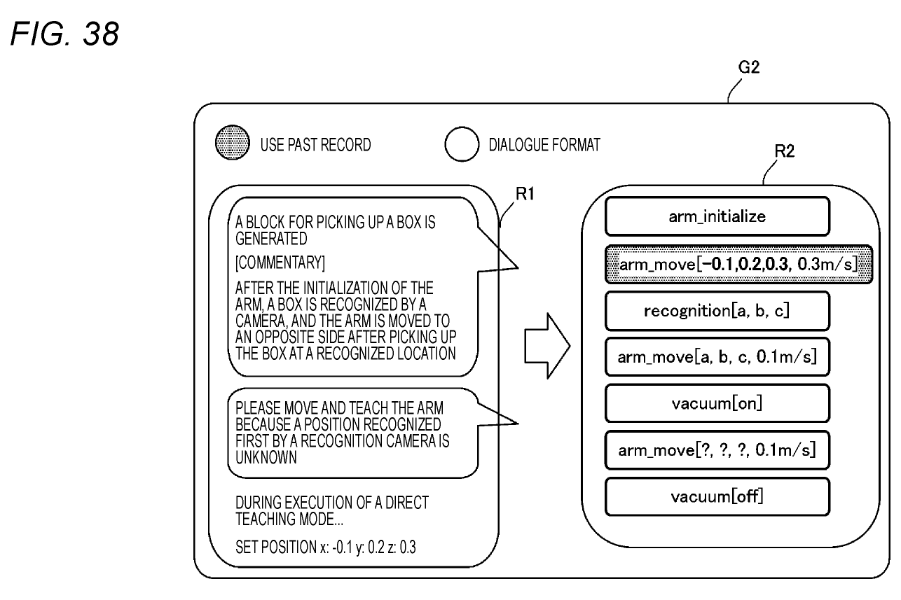

FIG. 38 is a diagram illustrating an example of reflection of first position information to the series of processing blocks in the use case.

The control unit 101 of the operation terminal 100 transmits the acquired position information to the automatic generation system 200 via the communication unit 103. The control unit 201 of the automatic generation system 200 acquires the position information from the operation terminal 100 via the communication unit 203, and reflects the position information in a corresponding processing block (second processing block). The control unit 201 transmits the processing block in which the position information is reflected to the operation terminal 100 via the communication unit 203. The control unit 101 of the operation terminal 100 acquires the processing block in which the position information is reflected via the communication unit 103, and causes the block display region R2 to display the processing block. Specifically, the control unit 101 changes the second processing block in which the position information is to be reflected from "arm_move [?, ?, ?, 0.3 m/s]" to "arm_move [-0.1, 0.2, 0.3, 0.3 m/s]", and displays the same.

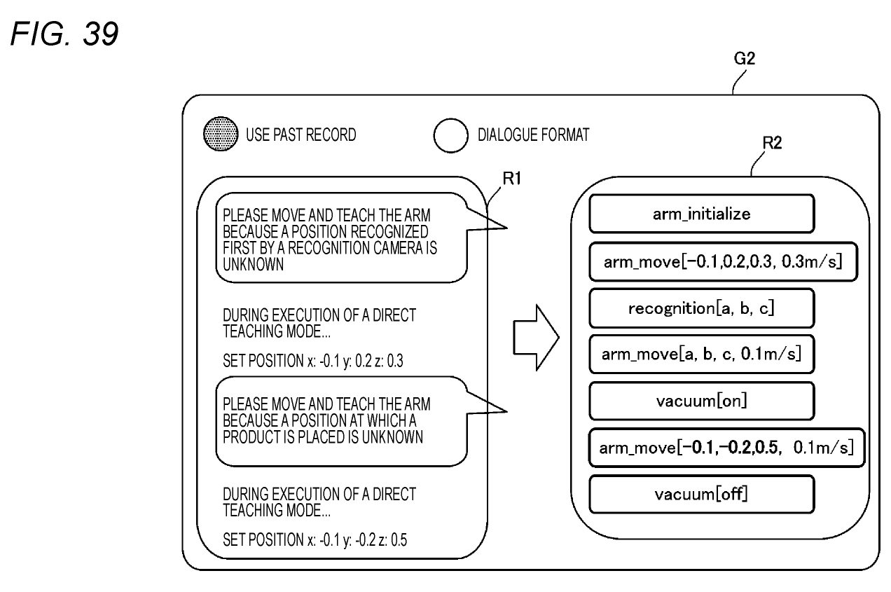

FIG. 39 is a diagram illustrating an example of reflection of the second position information to the processing blocks in the operation flow in the use case.

The operation terminal 100 and the automatic generation system 200 reflect the second position information as well as the first position information. Specifically, the user grips the arm of the robot and actually moves the arm to the second set position (for example, the place position). At this time, the sensor of the robot recognizes a position or angle of the arm, detects the second set position based on this recognition information, and transmits the position information of the set position to the operation terminal 100. The control unit 101 of the operation terminal 100 acquires the information on the detected set position via the communication unit 103, and causes the input display region R1 to display the information on the set position.

The control unit 101 of the operation terminal 100 transmits the acquired position information to the automatic generation system 200 via the communication unit 103. The control unit 201 of the automatic generation system 200 acquires the position information from the operation terminal 100 via the communication unit 203, and reflects the position information in a corresponding processing block (sixth processing block). The control unit 201 transmits the processing block in which the position information is reflected to the operation terminal 100 via the communication unit 203. The control unit 101 of the operation terminal 100 acquires the processing block in which the position information is reflected via the communication unit 103, and causes the block display region R2 to display the processing block. Specifically, the control unit 101 changes the sixth processing block in which the position information is to be reflected from "arm_move [?, ?, ?, 0.1 m/s]" to "arm_move [-0.1,-0.2, 0.5, 0.1 m/s]".

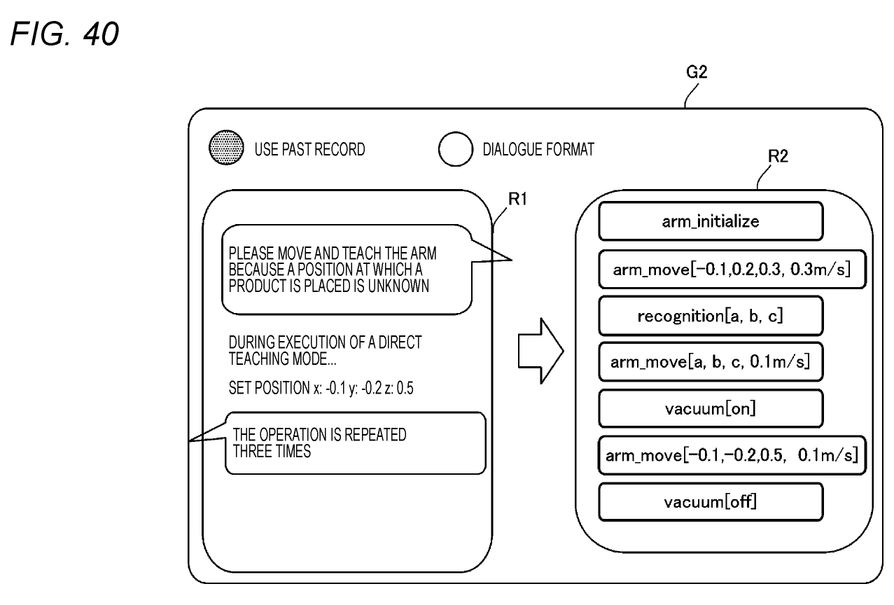

FIG. 40 is a diagram illustrating an example of correction of the operation flow in the use case.

In FIG. 40, it is assumed that the above operation flow is repeated three times. The control unit 101 of the operation terminal 100 inputs, for example, "repeat the operation three times" via the input unit 104, and causes the input display region R1 to display the input correction information. The operation terminal 100 transmits the input information including the input correction information to the automatic generation system 200.

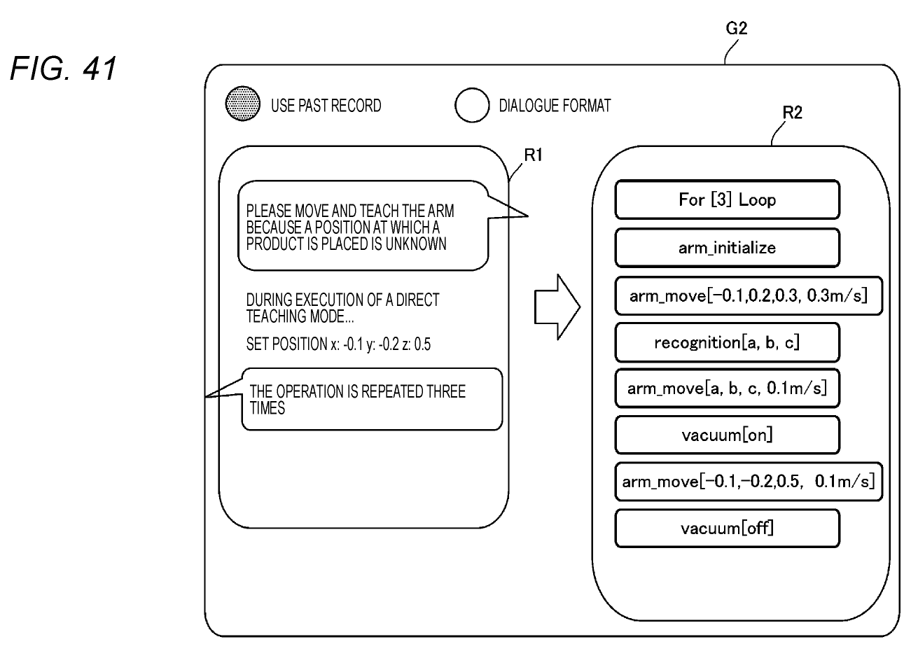

FIG. 41 is a diagram illustrating an example of regeneration of the operation flow in the use case.

The control unit 201 of the automatic generation system 200 generates a processing block (For [3] Loop) indicating that the operation is repeated three times based on the input information, and adds the processing block to the generated operation flow, thereby regenerating the operation flow and regenerating the block commentary information thereof. The control unit 201 transmits the output information, including the regenerated series of blocks and the block commentary information thereof, to the operation terminal 100 via the communication unit 203.

The control unit 101 of the operation terminal 100 acquires the output information via the communication unit 103 and displays the output information based on the output information. Specifically, the control unit 101 adds the processing block (For [3] Loop) to a head of the operation flow, and causes the block display region R2 to display the operation flow.

Therefore, the operation terminal 100 and the automatic generation system 200 can implement the setting of the insufficient position information, the correction of the operation flow, and the like by repeating the question and the answer in a dialogue format with the chat bot.

In this way, the program generation system 5 according to the present embodiment can automatically generate an operation using a generation AI (LLM) based on implementation contents to be automated, the device information of the robot 400 and the like, and usable block information. The program generation system 5 can generate this operation in units of processing blocks. Therefore, the user can generate an operation flow that reliably operates by inputting and outputting the operation flow without going through a program.

When the user is a beginner, even in a case in which the implementation content designated by the user is insufficient, the program generation system 5 can generate a processing block by supplementing the insufficient information based on the past record information or the information obtained in a dialogue format with the chat bot. That is, when the input implementation content is insufficient, the LLM can also generate a processing block with high accuracy.

The program generation system 5 can generate the block commentary information that comments on the series of generated processing blocks using the generation AI (LLM). Therefore, the program generation system 5 can promote understanding of the contents of the processing blocks even when the user is a beginner. Therefore, the program generation system 5 can easily generate the operation of the robot 400 according to a purpose of the beginner, and can easily assume the operation of the robot 400 based on the block commentary information. As a result, the robot beginner can also receive benefit of automation by the robot 400.

The program generation system 5 can cause the automatic generation system 200 to refer to an operation that can be executed in advance when the operation of the robot 400 is generated, as the information on the processing blocks, and output only the operation flow of the robot 400 that can be reliably executed. In addition, information on a position at which the robot 400 operating at the site moves depends on a situation of the site, and thus the position information can be supplemented by the direct teaching at the site or the user input.

In this way, the program generation system 5 can easily generate a program for allowing the beginner of the robot 400 to cause the robot 400 to perform a desired operation.

In the present embodiment, a case in which the operation terminal 100 and the automatic generation system 200 are configured separately is mainly illustrated, but the present disclosure is not limited thereto. The operation terminal 100 and the automatic generation system 200 may be configured by the same device (for example, a PC).

In the present embodiment, a case in which the operation terminal 100 acquires information from various DBs and transmits the information to the automatic generation system 200 is illustrated, but the present disclosure is not limited thereto. For example, the operation terminal 100 may receive the implementation content and transmit the implementation content information to the automatic generation system 200, and the automatic generation system 200 may acquire information from various DBs as a trigger when the automatic generation system 200 acquires the implementation content information. In this case, the automatic generation system 200 may receive information such as the implementation content information from the operation terminal 100, and the information acquired from various DBs as the input information, and perform processing such as the generation of the processing blocks or the block commentary information.

### Overview of Embodiments

As described above, at least the following matters are described in the present disclosure. Components corresponding to those in the above embodiments are shown in parentheses, but the present disclosure is not limited thereto.

### Item 1

A program generation method including:
acquiring device information related to a device including a robot (robot 400) that executes an operation;
acquiring block information related to a processing block group that is a collection of processing blocks in which operations that are capable of being handled by the device are set;
acquiring an implementation content by the robot; and
generating a program by selecting one or more processing blocks for implementing the implementation content from the processing block group based on the device information, the block information, and the implementation content.

Accordingly, the program generation method can easily generate a program for allowing the beginner of the robot to cause the robot to perform a desired operation. In this case, even if there is no specialized knowledge about the robot, it is not necessary to understand the robot itself or to understand the processing blocks deeply, and it is also not necessary to take time until learning to execute the operation of the robot.

### Item 2

The program generation method according to item 1, further including:
generating block commentary information that comments on the selected processing blocks based on the device information, the block information, and the selected processing blocks.

Accordingly, the program generation method can grasp whether to generate a program in which what kind of processing can be performed on the selected processing block.

### Item 3

The program generation method according to item 1 or 2, in which
the acquiring the device information includes
designating a device executable at a predetermined site based on the implementation content, and
acquiring the device information related to the designated device.

Accordingly, the program generation method can select the processing block and generate the program only for the processing executable by the on-site device, and thus a processing load at the time of generating a program can be reduced, and a time required for selection can be shortened.

### Item 4

The program generation method according to any one of items 1 to 3, further including:
acquiring past record information, which is information related to a record of the robot performing an operation related to the processing block, wherein
the generating the program includes generating the program by selecting the processing block based on the device information, the block information, and the past record information.

Accordingly, the program generation method can improve an accuracy of generating the program by selecting the processing block based on the past record of the actually executed operation.

### Item 5

The program generation method according to item 4, in which
the acquiring the past record information includes acquiring the past record information when the acquired information on the implementation content is insufficient.

Accordingly, the program generation method can generate a program for performing a desired operation in accordance with the implementation content even when the input of the implementation content by the beginner is insufficient.

### Item 6

The program generation method according to item 4 or 5, in which
the acquiring the past record information includes
generating the past record information, including a record processing block and record commentary information, by using the selected processing block as the record processing block and using block commentary information that comments on the selected processing block as the record commentary information,
storing the past record information in a storage unit (past record DB), and
acquiring the past record information from the storage unit.

Accordingly, the program generation method can present which processing block is selected to generate a program by accumulating the selected processing block and the commentary information thereof. In addition, the program generation method can utilize the accumulated processing blocks and the commentary information thereof.

### Item 7

The program generation method according to item 6, in which
the acquiring the past record information further includes
acquiring the record commentary information similar to the designated implementation content, and the record processing block corresponding to the record commentary information.

Accordingly, the program generation method can select a processing block so that the robot performs an operation that is executed in the past with the same content as the designated implementation content.

### Item 8

The program generation method according to item 6 or 7, in which
the acquiring the past record information further includes
excluding, when the record processing block includes position information related to a position of the device, the position information from the record processing block, and
the generating the program further includes
setting, to the selected processing block, position information of a position at which the device executable at a predetermined site is executable.

Accordingly, the program generation method does not add the position information included in the past record information so that the device is also executable in an environment different from an environment in which the device is executed in the past, and instead can select the processing block by using the position information in which an on-site situation is added.

### Item 9

The program generation method according to item 8, in which
the generating the program further includes
setting, to the selected processing block, the position information of the position at which the device executable at the predetermined site is executable, based on direct teaching to the robot executable at the predetermined site.

Accordingly, in the program generation method, for example, by holding a robot arm and making the robot arm perform a desired movement, position information when the robot performs the operation flow can be easily set in the selected processing blocks.

### Item 10

A program generation system (program generation system 5) including at least one control unit (control unit 201), in which
the at least one control unit is configured to
acquire device information related to a device including a robot that executes an operation;
acquire a block information group that is a collection of processing blocks in which operations that are capable of being handled by the device are set;
acquire an implementation content by the robot; and
generate a program by selecting one or more processing blocks for implementing the implementation content from the processing block group based on the device information, the block information, and the implementation content.

Accordingly, the same effect as that of item 1 is obtained.

Although various embodiments are described above with reference to the drawings, it is needless to say that the present disclosure is not limited to such examples. It is apparent that those skilled in the art can conceive of various modifications or corrections within the scope described in the claims, and it is understood that such modifications or corrections naturally fall within the technical scope of the present disclosure. The components in the above embodiments may be freely combined without departing from the scope of the invention.

### INDUSTRIAL APPLICABILITY

The present disclosure is useful in a program generation method and a program generation system capable of easily generating a program for causing a robot to perform a desired operation.

What is claimed is:

1. A program generation method comprising:
acquiring device information related to a device including a robot that executes an operation;
acquiring block information related to a processing block group that is a collection of processing blocks in which operations that are capable of being handled by the device are set;
acquiring an implementation content by the robot; and
generating a program by selecting one or more processing blocks for implementing the implementation content from the processing block group based on the device information, the block information, and the implementation content.

2. The program generation method according to claim 1, further comprising:
generating block commentary information that comments on the selected processing blocks based on the device information, the block information, and the selected processing blocks.

3. The program generation method according to claim 1, wherein
the acquiring the device information includes
designating a device executable at a predetermined site based on the implementation content, and
acquiring the device information related to the designated device.

4. The program generation method according to claim 1, further comprising:
acquiring past record information, which is information related to a record of the robot performing an operation related to the processing block, wherein
the generating the program includes generating the program by selecting the processing block based on the device information, the block information, and the past record information.

5. The program generation method according to claim 4, wherein
the acquiring the past record information includes acquiring the past record information when the acquired information on the implementation content is insufficient.

6. The program generation method according to claim 4, wherein
the acquiring the past record information includes
generating the past record information, including a record processing block and record commentary information, by using the selected processing block as the record processing block and using block commentary information that comments on the selected processing block as the record commentary information,
storing the past record information in a storage unit, and
acquiring the past record information from the storage unit.

7. The program generation method according to claim 6, wherein
the acquiring the past record information further includes
acquiring the record commentary information similar to the designated implementation content, and the record processing block corresponding to the record commentary information.

8. The program generation method according to claim 6, wherein
the acquiring the past record information further includes
excluding, when the record processing block includes position information related to a position of the device, the position information from the record processing block, and
the generating the program further includes
setting, to the selected processing block, position information of a position at which the device executable at a predetermined site is executable.

9. The program generation method according to claim 8, wherein
the generating the program further includes
setting, to the selected processing block, the position information of the position at which the device executable at the predetermined site is executable, based on direct teaching to the robot executable at the predetermined site.

10. A program generation system comprising at least one control unit, wherein
the at least one control unit
acquires device information related to a device including a robot that executes an operation;
acquires block information related to a processing block group that is a collection of processing blocks in which operations that are capable of being handled by the device are set;
acquires an implementation content by the robot; and
generates a program by selecting one or more processing blocks for implementing the implementation content from the processing block group based on the device information, the block information, and the implementation content.
